(19) United States
(12) Patent Application Publication
(10) Pub. No.: US 2005/0015443 A1
(43) Pub. Date: Jan. 20, 2005

(54) Personal message delivery system

(76) Inventors: Alex Levine, New York, NY (US); Gordon Gould, New York, NY (US); Carlo Martino, New York, NY (US); Peter W Merner, New York, NY (US); Harris Wulfson, Brooklyn, NY (US); Llewellyn Lafford, New York, NY (US)

Correspondence Address: Joseph Sofer;Sofer & Haroun, 317 Madison Avenue, Suite 910, New York, NY, 10017, US

(21) Appl. No.: 10/398,951

(22) PCT Filed: Oct. 10, 2001
(86) PCT No.: PCT/US01/31759

Related U.S. Application Data
(60) Provisional application No. 60/238,940, filed on Oct. 10, 2000.
(60) Provisional application No. 60/312,899, filed on Aug. 16, 2001.

(51) Int. Cl. G06F 15/16

(52) U.S. Cl. 709/204

(57) ABSTRACT

The present invention provides for a personal message system comprised of a plurality of interfaces configured to interface with a plurality of subscribers communication devices using a plurality of formats. A group services module is provided configured to maintain communications among groups of the subscribers. A platform conversion module is also provided and is coupled to the plurality of interfaces and the group services modules configured to connect each of the plurality of subscribers within a group, regardless of the communication protocols used by the subscribers.

### RELATED APPLICATIONS

This application is related to and claims priority to both U.S. Provisional Patent Application No. 60/238,940 entitled “A Personal Message Delivery System”, filed on Oct. 10, 2000, and U.S. Provisional Application No. 60/312,899 entitled “A Personal Message delivery system”, filed on Aug. 15, 2001, the entirety of which are incorporated herein by reference.

### FIELD OF THE INVENTION

The present invention relates to a personal message delivery system. More specifically, the present invention relates a cross platform personal message delivery system connecting member communities through the operation of a mobile community platform, a mobile content and commerce network and a mobile publishing toolset

### BACKGROUND OF THE INVENTION

Many systems are currently in place which interconnect people via electronic messaging services. These services include phones (mobile and fixed-line), pager services and text paging (SMS), wireless palm communicators, wireless internet and e-mail, all of which are designed -to provide mobile communication services to users. However, each particular system both wireless and standard (e-mail via PC and fixed-line phone) require different protocols to deliver the messages.

The drawback to these systems is that they are not well integrated As such, communications within a group are limited to the subscribers of a particular service provider. Subscribers of various service providers do not have the ability to interact For example, there is currently no ability if for people desire to form a group where, each communicates via different modes of operation; such as, one by cell phone, one by e-mail, one by paging, and one by paging with SMS.

Therefore, there exists a need for developing an enhanced personal message delivery system that allows people with various communication devices supported by various service providers to communicate in groups of their own design.

### SUMMARY OF THE INVENTION

In accordance with one embodiment of the present invention, a system is provided that fully integrates all personal communication forms including but not limited to mobile and fixed-line voice, SMS (mobile-terminated and mobile-originated), text paging (SMS), standard paging, web, e-mail, WAP & (Phone).com and instant messaging, such that a single message intended to reach a group of users is entered only once in any available format whereby it is automatically converted into all of the other necessary formats and delivered to all members of a group. Furthermore, the system comprises integrated components and navigation architecture to allow smooth cross platform transitions during system sessions.

### BRIEF DESCRIPTION OF THE FIGURES

FIG. 1 illustrates a personal message delivery system, in accordance with one embodiment of the present invention.

FIG. 2 illustrates a group services module, in accordance with one embodiment of the present invention.

FIG. 2A illustrates a message window, in accordance with one embodiment of

the present invention. FIG. 2B illustrates an administration web page, in accordance with one embodiment of the present invention.

FIG. 2C illustrates a create group page, in accordance with one embodiment of the present invention.

FIG. 3 illustrates a channel services module, in accordance with one embodiment of the present invention.

FIG. 3A illustrates a channel message history/channel configuration page, in accordance with one embodiment of the present invention.

FIG. 4 illustrates a subscriber information table, in accordance with one embodiment of the present invention.

FIG. 5 illustrates a message delivery subsystem call completion data table, in accordance with one embodiment of the present invention.

FIG. 6 illustrates a flow chart for a login and create account procedure, in accordance with one embodiment of the present invention.

FIG. 7 illustrates a flow chart for a subscriber joining a group, in accordance with one embodiment of the present invention.

FIG. 8 illustrates a flow chart for a subscriber joining a channel, in accordance with one embodiment of the present invention.

FIG. 9 illustrates a flow chart for a subscriber forming a new group, in accordance with one embodiment of the present invention.

FIG. 10 illustrates a flow chart for a subscriber sending an invite, in accordance with one embodiment of the present invention.

FIG. 11 illustrates a flow chart for a subscriber generating a text message, in accordance with one embodiment of the present invention.

FIG. 12 illustrates a flow chart for a subscriber generating a voice message, in accordance with one embodiment of the present invention.

FIG. 13 illustrates a flow chart for a subscriber receiving multimedia content via a WAP-SMS/IVR handler module, in accordance with one embodiment of the present invention.

FIG. 14 illustrates a flow chart for a subscriber communication via a virtual addressing scheme, in accordance with one embodiment of the present invention.

FIG. 15 illustrates a flow chart for the creation and operation of a poll in accordance with one embodiment of the present invention.

### DETAILED DESCRIPTION OF THE PREFERRED EMBODIMENTS

In one embodiment of the present invention, a cross-platform personal message delivery system 2 is provided, configured to provide a mobile community platform, a mobile content and commerce network and other independent services such as mobile home pages provided through a mobile publishing toolset.

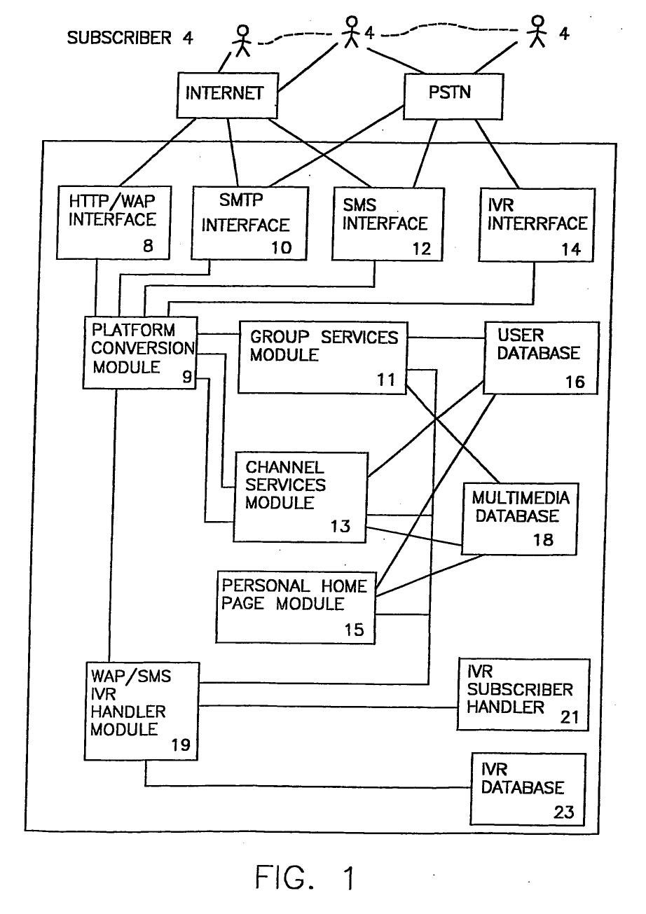

In one embodiment of the present invention, as illustrated in FIG. 1, personal message delivery system 2 is comprised of a number of internal modules and components configured to provide the subscribers 4 with a means to communicate with one another through various groups, channels and other means. Subscribers 4 is used throughout to refer to individuals with accounts in system 2. Subscribers 4 can refer to non-mobile device users as well as mobile device users, however, for the purposes of illustration, subscribers 4 will generally refer to mobile users of system 2. It should be noted that system 2 is available remotely to subscribers 4 of any mobile carrier and is not limited by any particular cellular provider or device manufacturer. As illustrated in FIG. 1, subscribers 4 contact system 2 via the internet or the public switched telephone network, based on the protocol preferred by subscriber 4.

In one embodiment of the present invention, as illustrated in FIG. 1, a Hyper Text Transfer Protocol (HTTP)/Wireless Application Protocol (WAP) interface 8 is provided. HTTP/WAP interface 8 is coupled to a platform conversion module 9, described below, and is configured to interface system 2 with subscribers 4 that connect to system 2 via the internet or wireless internet methods. In addition, HTTP/WAP interface 8 is configured to provide the principle interface for subscribers 4 to connect with system 2 both initially and when updating their account information.

HTTP/WAP interface 8 is preferably a single server or a load balanced cluster of servers Any one of the commercially available HTTP/WAP servers such as Apache, IM, and Tomcat servers or any other servers capable of interfacing between HTTP/WAP devices and system 2 are within the contemplation of the present invention.

In one embodiment of the present invention, as illustrated in FIG. 1, a Simple Mail Transfer Protocol (SMTP) e-mail interface 10 is provide& SMTP interface 10 is coupled to platform conversion module 9 and is configured to interface system 2 with subscribers 4 that connect with system 2 via e-mail and/or 2-way paging methods. SMTP interface 10 can be either a single-server or a load balanced cluster of servers. SMTP interface 10 can be any commercially available servers capable of interfacing with e-mail and 2-way paging devices.

In one embodiment of the present invention, as illustrated in FIG. 1, an SMS and paging messaging interface 12 is provided. Messaging interface 12 is coupled to platform conversion module 9 and is configured to interface system 2 with subscribers 4 that connect with system 2 via Short Messaging Service (SMS) and paging methods. Messaging interface 12 can be either a single server or an asymmetric cluster of servers. Messaging interface 12 can be any commercially available servers capable of interfacing with SMS and paging devices.

In one embodiment of the present invention, as illustrated in FIG. 1, a voice telephone and network IVR interface 14 is provided. IVR interface 14 is coupled to platform conversion module 9 and is configured to interface system 2 with subscribers 4 that connect with system 2 via voice telephone network methods. IVR interfaces 14 can be either a single server or a load balanced cluster of servers. IVR interface 14 can be any commercially available servers capable of interfacing with voice operating devices.

It should be noted that a single interface module could be used to maintain the functions of all the four interface modules for use in interfacing system 2 with subscribers 4 using various mediums including voice communications, SMS, paging, e-mail HTTP and WAP as well as other formats. However, for the purposes of illustration, separate modules for the IVR, HTTP/WAP, SMS and e-mail interfaces are used throughout as illustrative of the modules by which system 2 interfaces with their respective types of communications to and from subscribers 4. Any similarly operating cross-platform messaging system 2 which interfaces with subscribers 4 is within the contemplation of the present invention.

While only four major interface have be described this is in no way intended to limit the scope of the present invention. System 2 maintains a software design such that it is easily ungradable and expandable to cover any new technologies which subscribers 4 may be communicating with. For example, additional interfaces may include interfaces for platforms such as wireless PALM® devices, 3G mobile networks and other newly developing technologies. Any similar system which interfaces with subscribers 4 in order to provide a cross-platform communications network using a server interface, regardless of the platform serviced is within the contemplation of the present invention.

It should also be noted that the configuration and distribution of interface functions among these modules is intended as only one example of the configuration of interface module sin system 2. Various permutations of the distribution of interface functions between the interface modules is within the contemplation of the present invention.

In accordance with one embodiment of the present invention, subscribers 4 communicate to system 2 and to each other via virtual assigned phone numbers provided by a message delivery subsystem 17, described in more detail below. As such, since the number of subscribers 4 using system is almost always more that the number of trunk lines provided to system 2, in accordance with one embodiment a virtual address scheme is provided as described latter.

In one embodiment of the present invention, a platform conversion module 9 is provided, configured to connect each of the protocol interfaces 8, 10, 12 and 14 to the functional components of system 2. Platform conversion module 9 converts outgoing messages from system 2 into the appropriate format for each subscriber 4 as set by their preferences. Also, platform conversion module 9 converts incoming messages from subscribers 4 to system 2 into the appropriate format for all of the target subscribers 4 such that the sending subscriber 4 does not have to resend the message in different formats.

In addition to maintaining the functions of cross-platform conversion for incoming and outgoing messages to and from subscribers 4, platform conversion module 9 maintains LAN (Local Area Network)-Connections between interface modules 8, 10, 12 and 14. During ceratin functions of system 2 described below, some of the interfaces need to directly connect with one another to coordinate certain functions. For example, during a multimedia file transfer to a WAP user connected to system 2 through HTTP/WAP interface 8, IVR interface 14 and WAP interface 8 communicate with one another in order to coordinate the file transfer.

It should be noted that the functions listed above for platform conversion module 9 are intended only as certain examples and is in no way intended to limit the scope of the present invention. Additional uses for conversion module 9 may become necessary if additional modules are added to system 2. Any platform conversion module which works to translate message formats in a similar cross-platform message system 2 is within the contemplation of the present invention.

In one embodiment of the present invention, as illustrated in FIG. 1, a group services module 11 is provided, configured to supply system 2 with the means to manage and control a cross-platform mobile community of subscribers 4. Group services module 11 maintains several internal components described below which provide system 2 with a group feature allowing subscribers 4 to communicate with one another regardless of the devices used by the individual subscriber 4.

In one embodiment of the present invention, as illustrated in FIG. 1 a channel services module 13 is provided, configured to supply system 2 with the means to manage mobile content and commerce between subscribers 4 and advertisers on system 2. Channel services module 13 maintains several internal components discussed below which provide system 2 with a channel feature allowing advertisers and other interests to communicate sales, promotions information and more in a mobile format to interested subscribers 4, regardless of the mobile platform used.

In one embodiment of the present invention, as illustrated in FIG. 1 a personal home page module 15 is provided, configured to supply system 2 with the means to manage a personal home page and other similar services for subscribers 4 on system 2. personal home page module 15 provides system 2 with a personal mobile home page feature.

In one embodiment of the present invention, as illustrated in FIG. 1, an operations/user database 16 is provided. User database 16 is coupled to group services module 11, channel service module 13, personal home page module 15 as well as multi media database 18, described below. User database 16 is configured to store the web application information for system 2 as well as the subscribers 4 account information. User database 16 can be any commercial database, such as those produced by Oracle®, capable of handling the required information as well as being able to interface with the software and other components of system 2. User database 16 can exist either a single unit or as an asymmetric cluster of servers.

In one embodiment of the present invention, as illustrated in FIG. 1, a multimedia storage server 18 is provided. Multimedia storage database 18 is connected to group services module 11, channel service module 13, personal mobile web page module 15 and user database 16. Multimedia database 18 is configured to store multimedia content such as WAV (Windows Audio Volume) files associated with IVR interface 14 functions. Also, multimedia content from channel advertisers and other channel providers for use in delivery to subscribers 4 can be stored in multimedia storage database 18. Multimedia storage database 18 can be any commercial database capable of handling the required information as well as being able to interface with the components and software of system 2. Multimedia storage database 18 can exist either a single unit or as an asymmetric cluster of servers.

It should be noted that although user database 16 and multimedia storage database 18 are pictured as separate devices, this is in no way intended to limit the scope of the present invention. For example, both operations database 16 and multimedia storage database 18 can be a single database unit or, alternatively, a single asymmetric cluster, provided such single unit or single cluster can handle both the operations data storage and the multimedia storage for system 2. For the purposes of illustration, operations database 16 and multimedia storage database 18 will be depicted as separate databases, however any database configuration capable of supporting the requirements of a similar system 2 is within the contemplation of the present invention.

In one embodiment of the present invention, as illustrated in FIG. 1, a message delivery system 17 is provided, coupled to IVR interface 14 configured to create and store the number directories for subscribers 4. In the event a service provider offers system 2 less trunk lines than there are subscribers 4 on system 2 with that provider, message delivery system 17 operates to create a virtual numbering system, so that subscribers 4 can communicate on mobile phone devices between one another using a virtual number system, described in more detail below.

In one embodiment of the present invention, as illustrated in FIG. 1, a WAP-SMS/IVR handler module 19 is provided, coupled to platform conversion module 9, group services module 11 and channel services module 13, configured to maintain the logical command flow for the IVR and WAP (a well as passive SMS) functions of system 2. The logical command flow refers to the numeric command structure of the IVR interface (ie. Press 1 to hear new messages, press 2 to hear old messages etc.)

WAP-SMS/IVR handler module 19 of system 2 provides the function of cross platforming the logical command flow such that when a subscriber enters system 2 via WAP protocol instead of using the IVR interface, handler module 19 automatically converts the logical command flow into WAP protocol such that the logical command flow for IVR, WAP and passive SMS (if available) are interchangeable. Selections made in either protocol will be treated the same by system 2.

In one embodiment of the present invention, as illustrated in FIG. 1, an IVR subscriber handler 21 is provided, coupled to WAP-SMS/IVR handler module 19 and to an IVR database 23, configured to provide system 2 with outside multimedia content coupled with an IVR response, such that the content functions are managed by TV interface 14R For example, if IVR subscriber handler 21 wished to provide subscribers 4 with some media content, coupled with the ability to listen (option 1), order (option 2), hear different content (option 3), etc., IVR subscriber handler module 21 would provide the IVR logical command flow to WAP-SMS/IVR handler module 19 such that system 2 could administrate and deliver their content to the appropriate subscribers 4.

In one embodiment of the present invention, as illustrated in FIG. 1, an IVR/WAP database 23 is provided, coupled to WAP-SMS/IVR handler module 19 and IVR subscriber handler module 21, configured to store the media content for use in the transfer of media to subscribers 4 of system 2 as dictated by their selections entered in response to the options presented by IVR subscriber handler module 21. A more complete description of the function and operation of the delivery of media content through IVR subscriber handler module 21 and IVR media database 23 is discussed below in more detail.

In one embodiment of the present invention, system 2 utilizes redundant components for each of the individual modules utilized such that up-time for system 2 is not compromised during updating, high-volume time, and/or in the event of any component failures.

In one embodiment of the present invention, as illustrated in FIG. 1, all of the components of system 2 are located in a single location such that all of the physical modules used to run system 2 are located locally. However, this is in no way intended to limit the scope of the present invention. For example, all of the components of system 2 such as HTTP/WAP interface 8, SMTP interface 10, messaging interface 12, and IVR interface 14 can be located remotely. In fact, it is possible that some or all of the components of system 2 be maintained off site by a third party such that system 2 headquarters is solely for the purpose of monitoring system 2 activity. As such, any similar system 2 which operates to provide a cross platform messaging service to connect subscribers 4 which utilizes similar modules and software during operation is within the contemplation of the present invention.

As the physical location is not relevant to the functional aspects of any components, for the purposes of illustration, system 2 will be discussed through out as simply a collection of the appropriate functional modules and their respective connectivity,, regardless of their physical location.

The software which operates on the modules of system 2 is preferably written in JAVA® programming language. The programming language used by system 2 is preferably designed in layers such that all of the programming for the modules of system 2 are insulated against the inner workings of all of the other modules in system 2. Thus, in operation, the programing used by the various modules of system 2 operates on independent layers for each of their respective different functions such that software modifications to any one particular area or module of system 2 will not require knowledge of or alteration of software for any other part or module of system 2.

It should be noted that the general software architecture discussed above is intended only as an example of one possible software configuration for system 2, and is in no way intended to limit the scope of the present invention. For example, any software architecture either commercially available or independently designed that operates a similar system 2 so as to provide cross-platform communications to a plurality of subscribers 4 is within the contemplation of the present invention.

The principle means by which subscribers 4 enter and use system 2 is maintained by the web application. The software which runs on system 2, HTTP/WAP server 8 and operations database 16 provide a web architecture which supplies subscriber 4 with a means to open an account, select preferences, register mobile and non-mobile devices and generally operate their account The following components provide the bulk of the interface utility architecture used by system 2 to maintain its accounts.

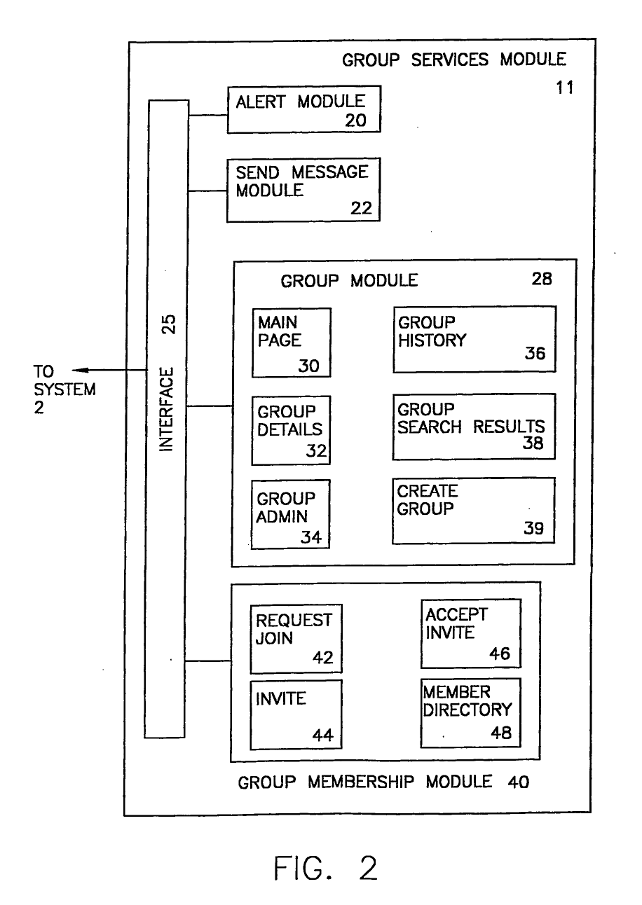

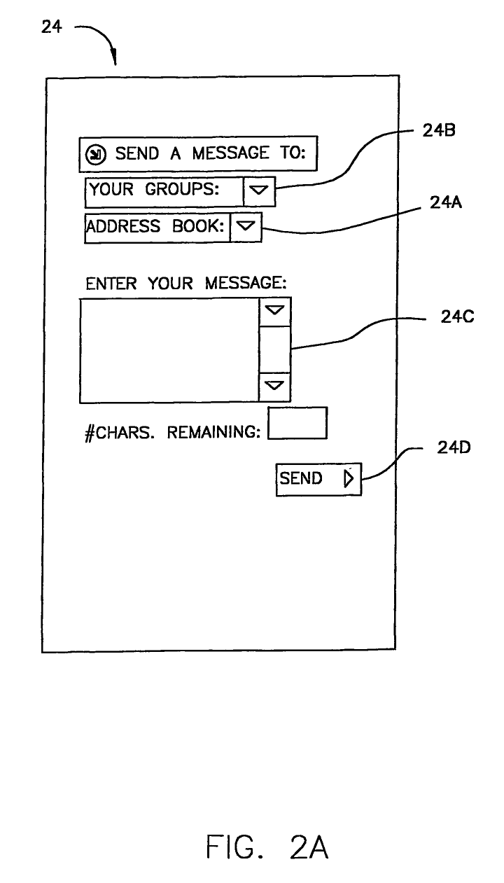

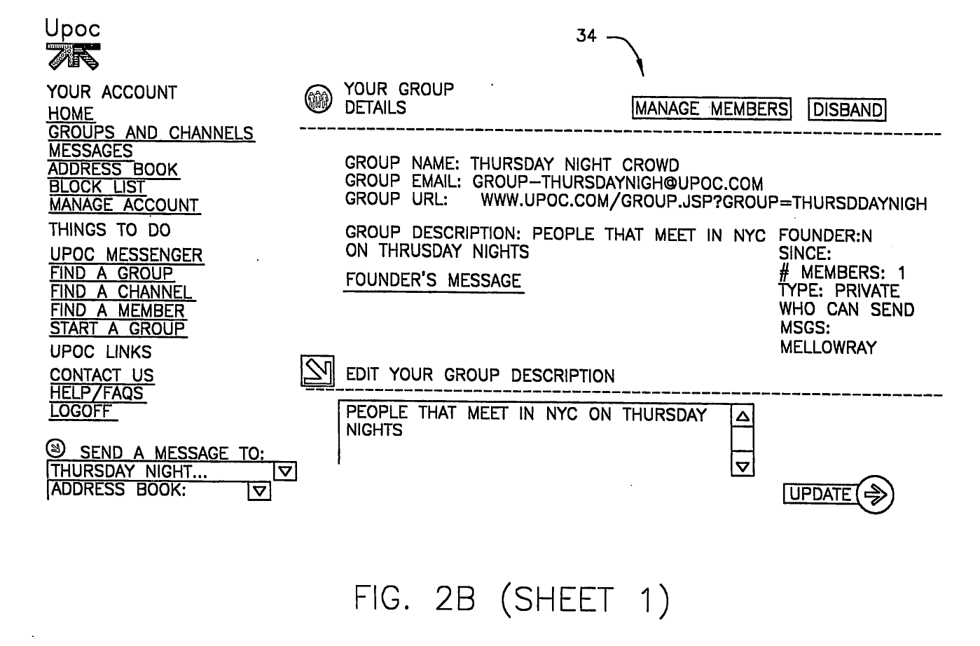

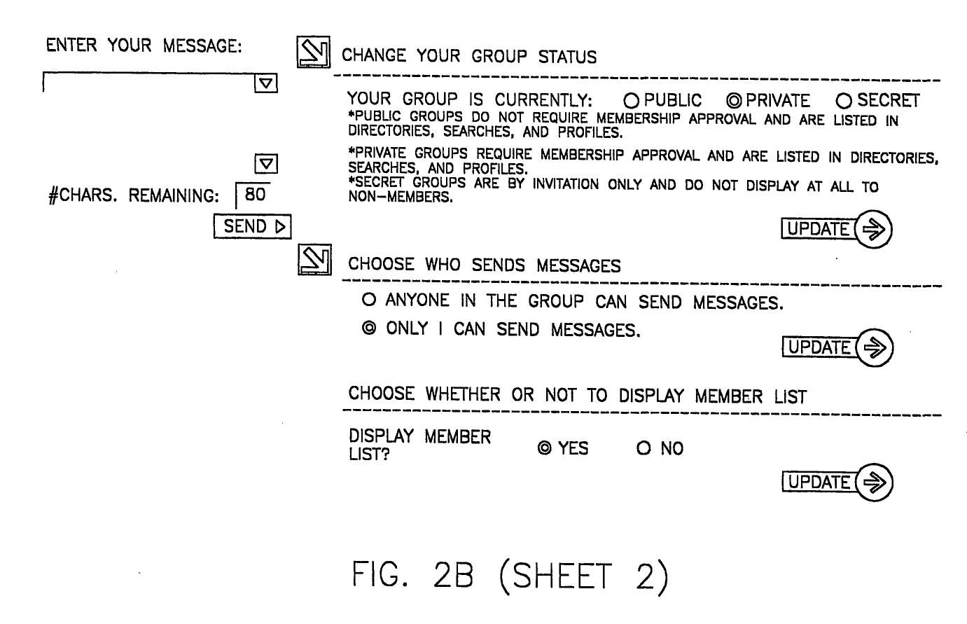

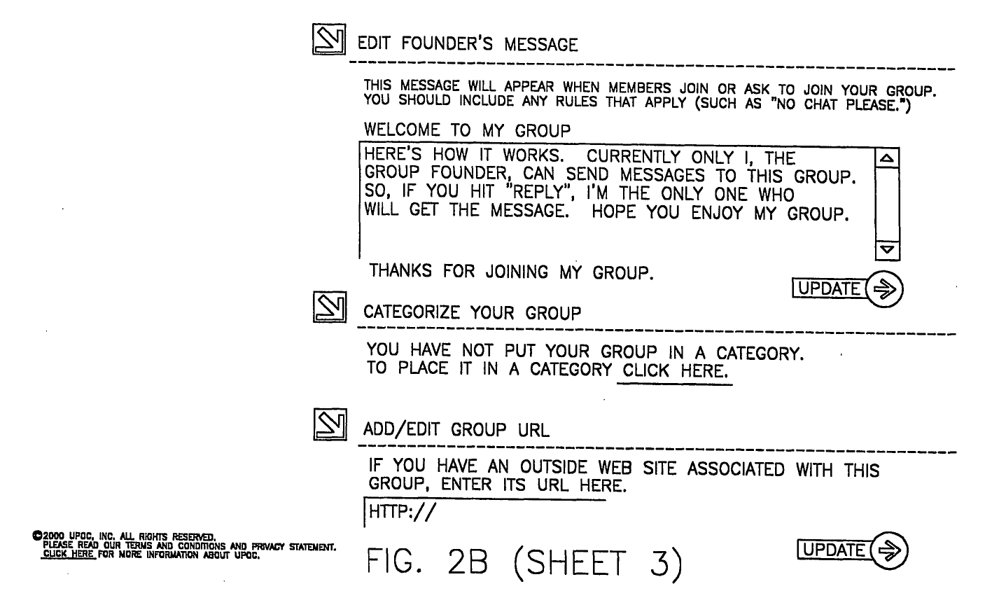

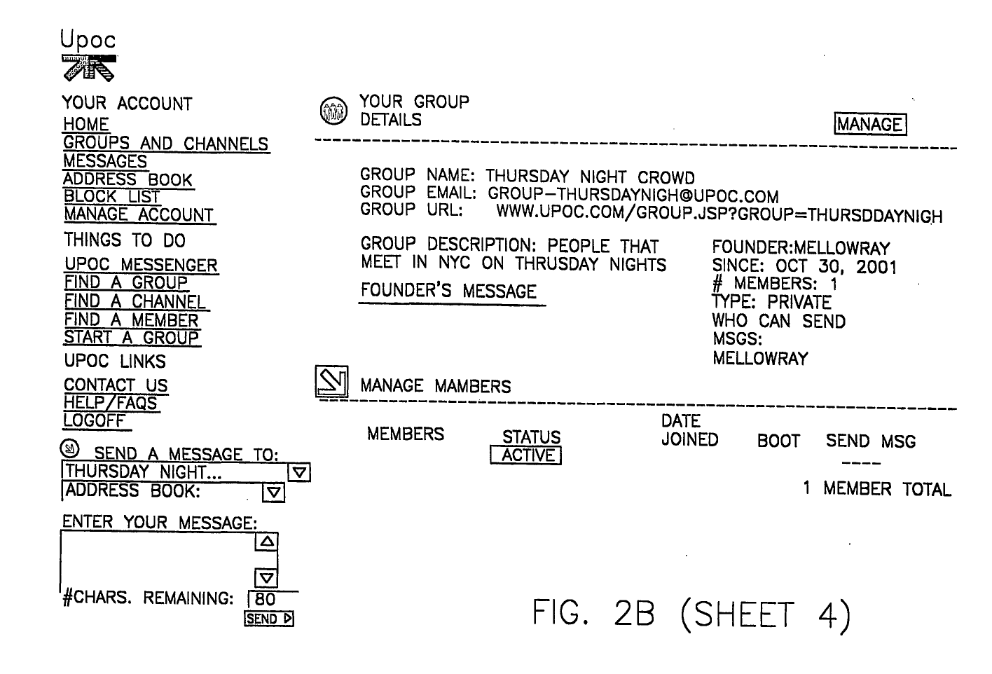

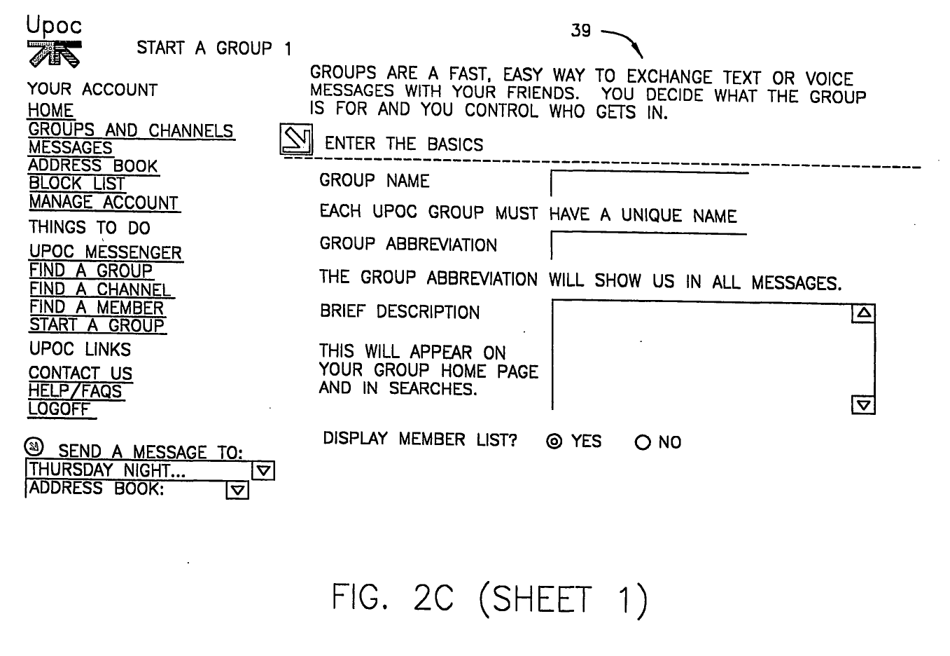

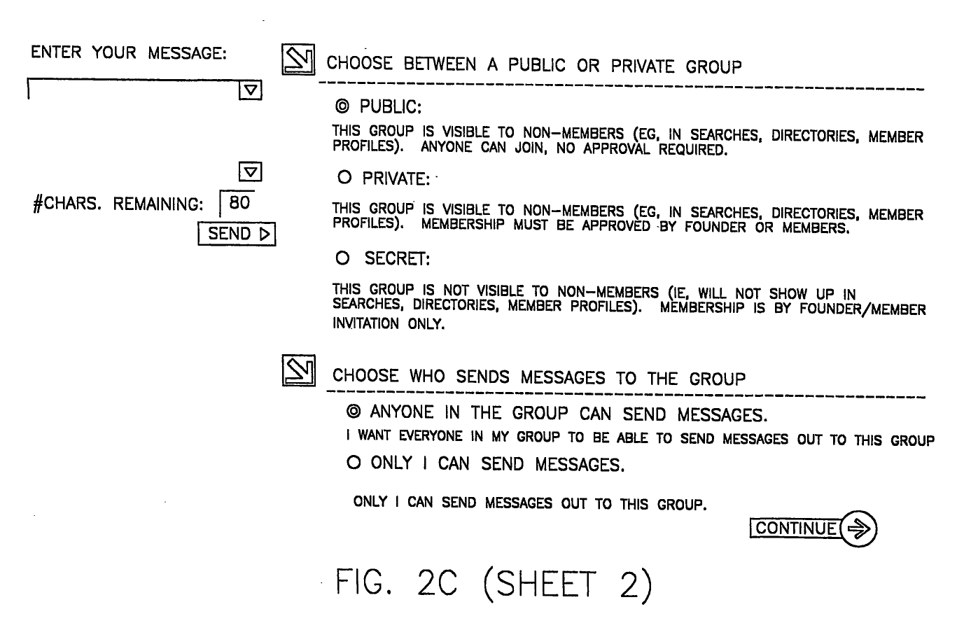

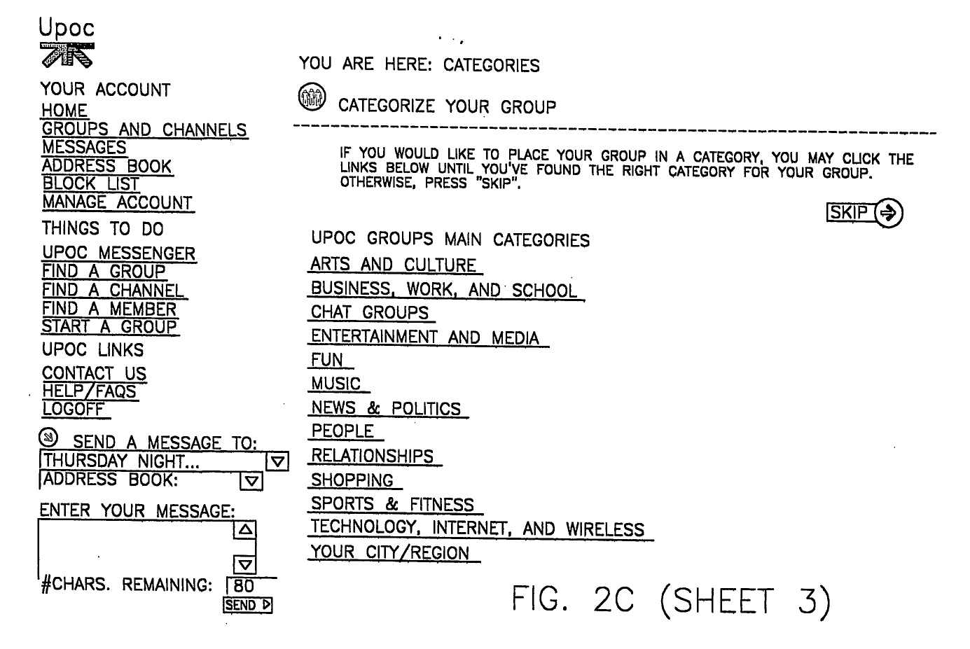

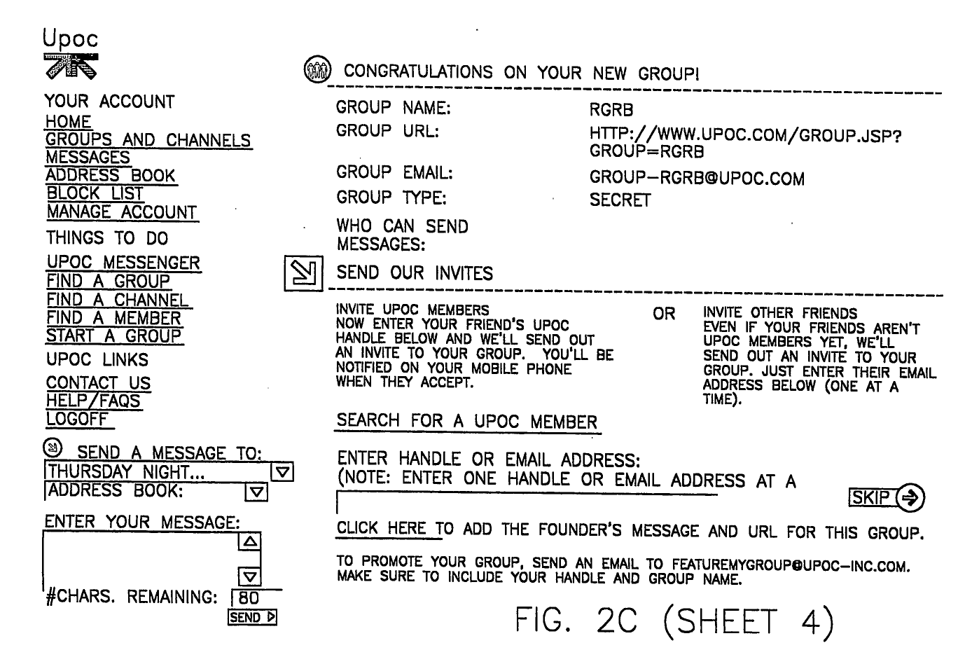

In one embodiment of the present invention, as illustrated in FIG. 2, group services module 11 maintains many internal component modules which provide group services module 11 with the ability to carry out its functions in system 2. The internal components of group services module 11 include but are not limited to alert module 20, send message module 22, group module 28, group membership module 40 and group interface module 25.

This list of internal components for group services module 11 is intended only as an example of one possible configuration and in is in no way intended to limit the scope of the present invention. Additional modules may be added increasing the functional capabilities of group services module 11. Any similar cross-platform group service module operating in a similar cross-platform system is within the contemplation of the present invention.

Alert module 20, coupled to group interface module 25, is configured to provide alert messages to subscriber 4, displayed on the various group web pages generated by system 2 as an alert button or panel on all of the pages required to provide alert notices functionalities to subscriber 4. In one embodiment of the present invention, alert module 20 provides alert buttons/panels on these web pages to inform subscribers 4 as to certain events and/or issues that need to be addressed. For example, such alert messages can include but are not limited to; unheard voice mail alerts, unvalidated device alerts, membership requests, record handle requests, record group name requests, vacation alert/no device in use, invitations to join a group, etc. In such instants where an alert button is used for a subscriber 4, the alerts is usually accompanied by a description of the alert and possibly a link to the appropriate web page where that alert can be properly addressed if applicable.

In addition to alert buttons/panels displayed on web pages, alert module 20 is also configured to send alert messages to subscribers 4 based on their preferences. For example, if a subscriber wishes to be notified of a received voice mail, they may wish to have an alert notice sent to their mobile device alerting them to the message. Thus, in addition from posting the alert on the subscriber's 4 account in web page format in system 2, alert module also creates and sends SMS/e-mail text message alerts to the same subscriber 4, such that they are notified even before they logon to system 2.

Send message module 22, coupled to group interface module 25, is configured to provide system 2 with the ability to allow subscribers 4 that are members of a group to send messages via a send message window 24 displayed on various group web pages which require such message sending functionality. Message windows 24, as illustrated in FIG. 2A, provides subscriber 4 the ability to create a message by filling in the appropriate windows and pressing a send button.

As illustrated in FIG. 2A, message window 24 is comprised of address book line 24a, group line 24b, message block 24c and send button 24d. In operation, group line 24b is defaulted to the group that subscriber 4 is currently in, however, subscriber can change the addressee by simply using the pull down arrows in address line 24a and group line 24b. Message block 24c is configured to receive the text message, which is ultimately sent to addressee upon the activation of send button 24d. A more complete description of the function of message window 24 and how it is used in the overall operation of system 2 is discussed in more detail below.

Group membership module 40, coupled to group module interface 25, is configured to allow subscribers 4 to utilize the group functions of system 2 such as inviting others to join and requesting to join particular groups. In operation group membership module 40, provides group members subscribers 4 with a number of window interfaces in which to conduct the operations of inviting members and requesting to join group, as is discussed later.

Some of the functions of group membership module 40 may include but are not limited to a request to joint utility 42, an invite to group utility 44, an accept invite utility 46, and a member directory utility 48. Request to join utility 42 allow subscribers 4 to request to join an invite-only status group. Invite to group utility 44 allows a founder and/or member subscribers 4 of group to invite a non-member subscribers 4 to that group. Accept invite utility 46 allow the invited subscriber 4 to accept or reject the offer to join the group. Directory utility page 48 allows a subscriber 4 to review all of the member subscribers 4 of a particular group based on the members' user ID so as to check their active/inactive status or any other information that subscriber 4 has chosen to make public.

Group module 28, coupled to group services module interface 25, is configured to support the basic multiuser cross-platform group functions for system 2. Group module 28 allows subscribers 4 to search, join and/or create, manage and review messaging groups for sending and receiving messages.

In order to support the group functions of system 2 group module 28 maintains several utilities which facilitate this process. Some of the utilities supported by group module 28 may include but are not limited to main page utility 30, group details utility 32, group administration utilities 34, group history utility 36, group search results utility 38 and create group utility 39.

Group main page utility 30 provides web pages which give a brief description of what the groups do and/or what the messages are related to. Group detail utility 32 provides web pages which explain the details of the group such as frequency of messages, status of group (open, invite only or secret), and other information.

Group administration utility 34 provides web pages, as illustrated in FIG. 2B which allow subscribers 4 authorized to manage a group (usually only the creator) a means for doing so. The group owner can make administrative decisions for the group including but not limited to approving and denying new member subscribers 4, removing members (presumably for bad behavior or parameter violations) and entering/editing the group description. In order to provide these capabilities, the group administration utility provides a web page, illustrated in FIG. 2B which maintains a list of pending join requests with links to approve or decline, a list of current member subscribers 4 with a link to remove them, a link to toggle public/private/secret group designation and a form for editing club description text and the ability to operate other administrative functions.

A group history utility 36 provides web pages which allow subscribers 4 to view of the recent history of the messages that have been sent in a particular group so as to evaluate whether or not to join and/or to catch up on missed messages. Group search result utility 38 provides web pages which list the results of a search conducted by subscriber 4 so as to list all of the groups which meet the search criteria (except for secret groups).

Start group utility 39 provides web pages, as illustrated in FIG. 2C which allows a subscriber 4 to create their own group. In order to create the group, create group utility 39 requests a name and description for the group, type of group (public, private or secret), who can send messages to the group, what category the group is in if any (for category searches), what geographic region the group is in and the names/handles of the other subscribers 4 the creator wants to invite to their group. A more complete description of the process involved in creating a group is described in more detail below.

It should be noted that the above description of the utilities provided by group module 28 for performing the various processes available in system 2 regarding group functions are intended only as an example of one possible format for the utilities and is in no way intended to limit the scope of the present invention. Any similar utility architecture in a group module which can support member-group functions in a similar cross-platform messaging system 2 is within the contemplation of the present invention.

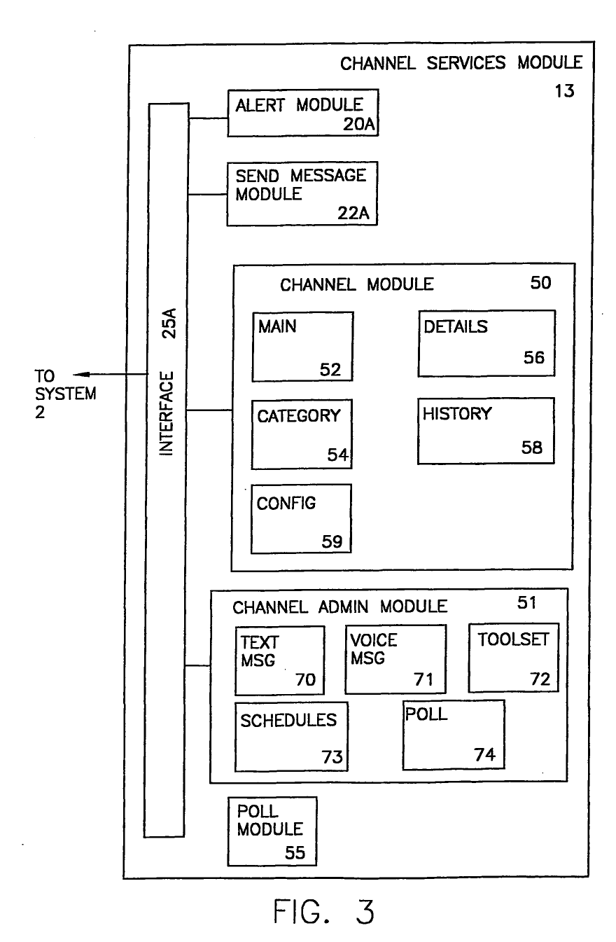

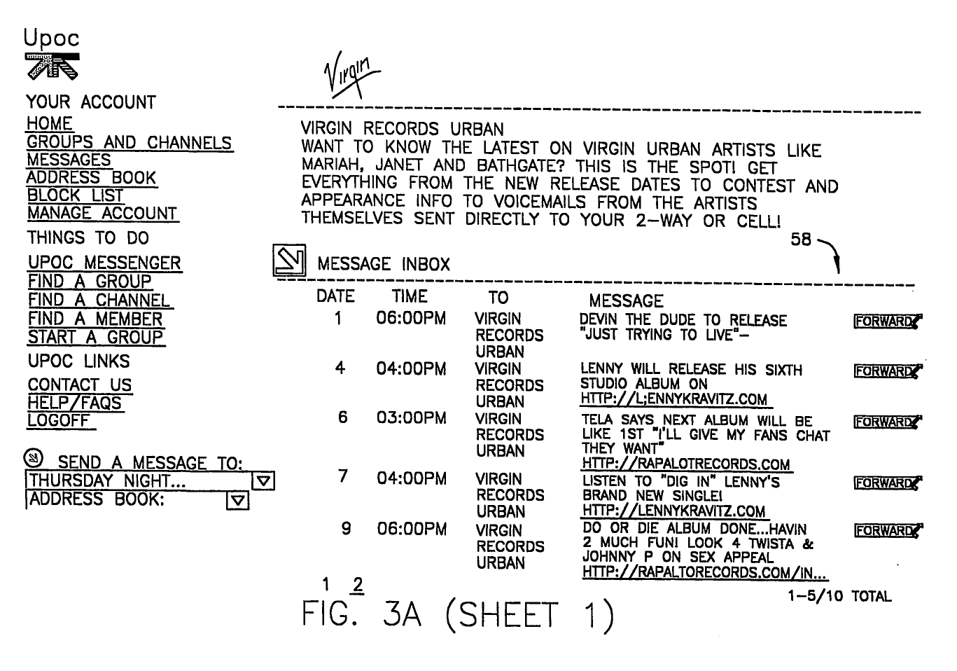

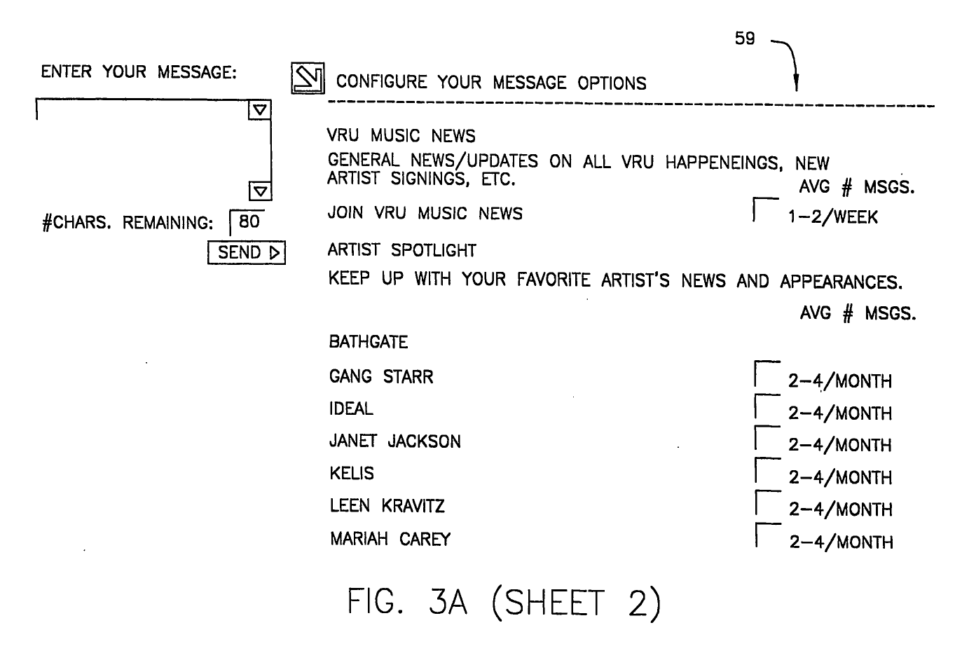

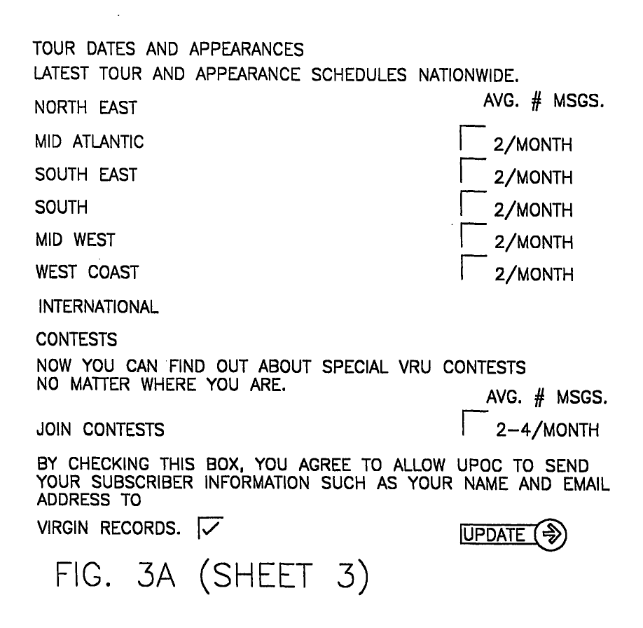

In one embodiment of the present invention, as illustrated in FIG. 3, channel services module 13 is comprised of several components including an alert module 20a, a messaging module 22a, channel module 50, a channel administration module 51, a channel services module interface 25a and a polling module 55. This list of the components of channel services module 13 is intended on as an example of some of the operational components of this module and is in no way intended to limit the scope of the present invention. Components may be added and deleted as necessary to accommodate consolidation, upgrade, new features and deleted features.. Any similar channel services module which operates in conjunction with a similar cross-platform messaging system is within the contemplation of the present invention.

Alert module 20a, coupled to channel interface module 25a, is configured to provide alert messages to subscriber 4, displayed on the various channel web pages generated by system 2 as an alert button or panel on all of the pages required to provide alert notice functionalities to subscriber 4. In one embodiment of the present invention, alert module 20a provides alert buttons/panels on these web pages to inform subscribers 4 as to certain events and/or issues that need to be addressed. For example, such alert messages can include but are not limited to; unheard voice mail alerts, unvalidated device alerts, membership requests, record handle requests, vacation alert/no device in use, invitations to join a channel, etc. In such instants where an alert button is used for a subscriber 4, the alert notice is usually accompanied by a description of the alert and possibly a link to the appropriate web page where that alert can be properly addressed if applicable.

In addition to alert buttons/panels displayed on web pages, alert module 20a is also configured to send alert messages to subscribers 4 based on their preferences. For example, if a subscriber wishes to be notified of a received voice mail, they may wish to have an alert notice sent to their mobile device alerting them to the message. Thus, in addition from posting the alert on the subscriber's 4 account in web page format in system 2, alert module also creates and sends SMS/e-mail text message alerts to the same subscriber 4, such that they are notified even before they logon to system 2.

Send message module 22a, coupled to channel interface module 25a is configured to provide system 2 with the ability to allow subscribers 4 to send messages via a send message window 24 displayed on various channel web pages which require such message sending functionality. Message windows 24, as illustrated in FIG. 2A, provides subscriber 4 the ability to create a message by filing in the appropriate windows and pressing a send button.

As illustrated in FIG. 2A, message window 24 is comprised of address book line 24a, group line 24b, message block 24c and send button 24d. Subscriber can set the addressee by simply using the pull down arrows in address line 24a and group line 24b. Message block 24c is configured to receive the text message, which is ultimately sent to addressee upon the activation of send button 24d. A more complete description of the function of message window 24 and how it is used in the overall operation of system 2 is discussed in more detail below.

Channel module 50, coupled to channel service module interface 25a, is configured to support the channel functions of system 2 from a subscriber perspective channel module 50, maintains several utilities which support these functions which may include but are not limited to channel main page utilities 52, channel category utilities 54, channel details utilities 56, channel history utilities 58, and channel configuration utilities 59.

Channel main page utilities 52 provides a web page which displays the all of the available channels, channel options as well as feature channels. Channel category utilities 54 list the existing channels by category. Channel details utilities 56 allow subscriber 4 to review the details of channel before signing up, such as how frequently messages are sent, and what sort of content they provide. Channel history utilities 58 provides web material, as illustrated in FIG. 3A which allows subscriber 4 to review past messages on the channel in order to determine whether or not to join and/or to catch up on missed messages.

In one embodiment of the present invention, channel configuration utility 59 allow a member subscriber 4 to specify their preferences regarding channel messages, such as how often they wish to receive information, and which particular information they want.

Channel configuration utility 59 provides a web page, as illustrated in FIG. 3A, which provides subscriber 4 with a number of choices as to which content they wish to receive and how often they would like to receive it. For example, web pages, as illustrated in FIG. 3 provided by channel configuration pages include various types of messages supplied by the content provider which can be ordered or skipped by subscriber 4 when selecting their preferences.

It should be noted that the above description of the utilities regarding the various processes available in system 2 regarding channel functions was intended only as an example of one possible format for the pages and is in no way intended to limit the scope of the present invention. Any similar web page architecture which can support member-channel functions in a similar cross-platform messaging system 2 is within the contemplation of the present invention.

Channel provider module 51, coupled to channel service module interface 25a is configured to support the channel functions of system 2 from a channel content provider's perspective. Channel provider module 51, maintains several utilities which support these functions which may include but are not limited to send text message to channel utilities 70, send voice message to channel utilities 71, channel tools utilities 72, schedule channel messages utilities 73 and channel polling utilities 74.

In one embodiment of the present invention, channel send text message utilities 70 and channel send voice message utilities 71 provide web functions which allow a channel provider to create and send messages to member subscribers 4. In addition to sending basic messages, channel providers may include direct or indirect links to their products via IVR subscriber module 21 and IVR database 23 such that content can be advertised delivered and sold to member subscribers 4 while they are logged in through WAP and/or IVR protocol sessions. A complete description of this process is described below.

In another embodiment of the present invention, the channel operator can also utilize the channel scheduled message utilities 73 which provider greater versatility in creating messages in advance to be sent periodically based on the channel provider's instructions. The channel scheduled message utilities 72 also allow the channel provider the opportunity to re-arrange, delete, re-schedule, edit the message before they are sent.

In one embodiment of the present invention, the channel tools utilities 72 are utilized by the channel providers to create and manage the content of their channel. These tools allow the channel provider to set their description, their logo, and their available configurations to send messages to these subscriber 4 (as it appears in the subscriber 4 side configuration utilities 59, described above).

In another embodiment of the present message, channel poll utilities 74 provide web applications configured to allow the channel provider to create and manage an on-the-fly poll to be delivered to the member-subscribers 4 of that channel. The poll questions can range from movie reviews, to sports event outcomes or any other events relevant to that channel's content. The poll's interactive distribution and responses are handled by channel poll module 53 discussed below.

It should be noted that the above description of the utilities provided by channel module 50 and channel provider module 51 for performing the various processes available in system 2 regarding channel functions was intended only as an example of one possible format for the utilities and is in no way intended to limit the scope of the present invention. Any similar utilities architecture in a channel module which can support member-channel functions in a similar cross-platform messaging system 2 is within the contemplation of the present invention.

In one embodiment of the present invention, polling module 53, coupled to channel services module interface 25a and channel provider module 51, is configured to manage the dissemination and responses to polls conducted by the channel provider. Poll module 53 works in conjunction with other system 2 components such as WAP-SMS/IVR handler module 19, platform conversion module 9 and the various interface modules of system 2 to disseminate the polls in such a way that the responses can easily be handled by subscribers 4, regardless of the communication protocol that subscribers 4 is using.

It should be noted that the above list of components in channel services module 13 is intended only as an example and is in now ay intended to limit the scope of the present invention. Any similar channel service module operating in conjunction with a similar cross-platform message system is within the contemplation of the present invention.

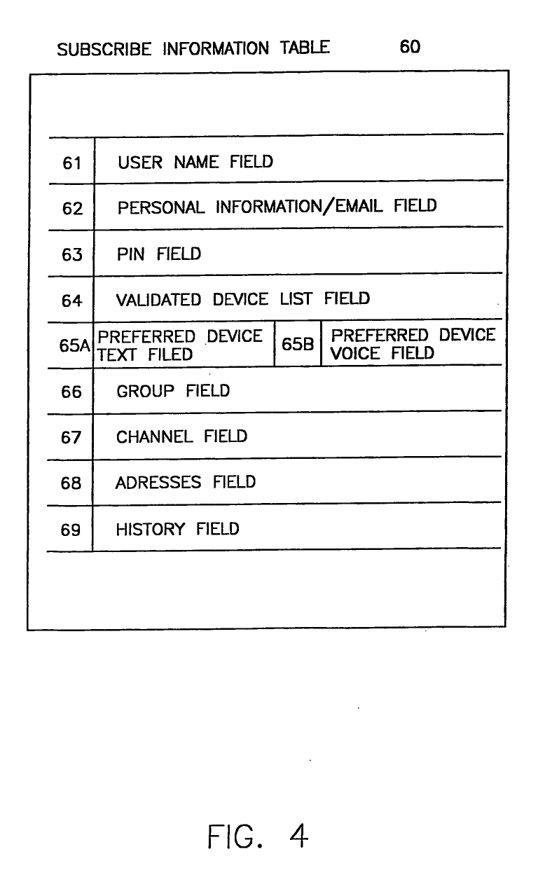

In one embodiment of the present invention, as illustrated in FIG. 4, subscriber information is stored in a subscriber information table 60 as stored in user database 16. Subscriber table 60 maintains all of the pertinent information about subscriber 4 that system 2 requires to properly handle the accounts of and send messages to its users. The information contained therein is supplied by the user either initially upon entering system 2 or it is supplied/edited at a later date. The information is processed through a web interface, where subscriber 4 can enter their information. Additional means for entering the information are available such as through WAP sessions or other protocols that are capable of adequately transferring the necessary information.

In one embodiment of the present invention as illustrated in FIG. 4, subscriber table 60 maintains multiple fields so as to organize the subscriber 4 information. Fields contained within subscriber table 60 may include but are not limited to: username field 61, personal information field 62 (including e-mail), PIN number field 63, device list field 64 (with validation flags), device/alert message preference fields 65a (text) and 65b (voice), group memberships field 66, channel memberships field 67, address book field 68, and message history fields 69.

It should be noted that the examples listed above for fields in subscriber table 60 are intended only as examples, and are in no way intended to limit the scope of the present invention. Additional information fields can be added or redundant fields can be deleted provided the aggregate result provides sufficient information to support the functions of system 2.

In one embodiment of the present invention, as illustrated in FIG. 4, subscriber table 60 maintains a username field 61 is configured to store information regarding subscriber's 4 screen name also referred to as handle. This username is used through out system 2 to identify a subscriber 4 to other subscribers 4 without revealing their true identity. Personal information field 62 is provided, configured to store information regarding the real name, address, telephone number(s), e-mail addresses and other information of subscriber 4. This information is used for accounting purposes and to identify subscriber's 4 e-mail address if that is chosen as a preference for receiving messages. PIN (Personal Identification Number) field 63 is provided to store information regarding subscriber's 4 PIN used by subscriber 4 to gain access to their accounts in system 2.

In one embodiment of the present invention, as illustrated in FIG. 4, subscriber table 60 maintains device list field 64 configured to store information regarding all of subscriber's 4 devices that have been validated by system 2. Validated devices are S devices acknowledged by system 2 as compatible with at least some of the functions of system 2. Each listing in the validated devices field, maintains the contact number for that device the maker of the device and the service provider which operates the device.

Device alerts/messages preferences field 65a (text) and 65b (voice) are configured to store information regarding which validated device subscriber 4 prefers to receive their messages on. For example, the device preferences field 65a(text) notes the device subscriber 4 wishes to receive their text messages and device preferences filed 65b(voice) notes which device subscriber 4 wishes to receive their voice messages.

In one embodiment of the present invention, as illustrated in FIG. 4, subscriber table 60 maintains group memberships field 66 configured to store information regarding the groups subscriber 4 is a member.

Channel memberships field 67 is provided to store information regarding the channels subscriber 4 is a member. Address book field 68 configured to store information regarding all of the other subscribers 4, that a subscriber has contacted in the past. The information in address book filed 68 is stored based on the other subscriber's username information. Message history field 69 configured to store information regarding a number of the most recently received messages from groups and/or subscribers from system 2.

Subscribers 4 enter and edit all of the information in subscriber table 60 through the use of interface web pages supplied by system 2. It should be noted that the above fields for subscriber table 60 are intended only as an example of one possible format for subscriber table 60 and is in no way intended to limit the scope of the present invention. Any similar subscriber table which can support subscriber account information on a similar cross-platform messaging system 2 is within the contemplation of the present invention.

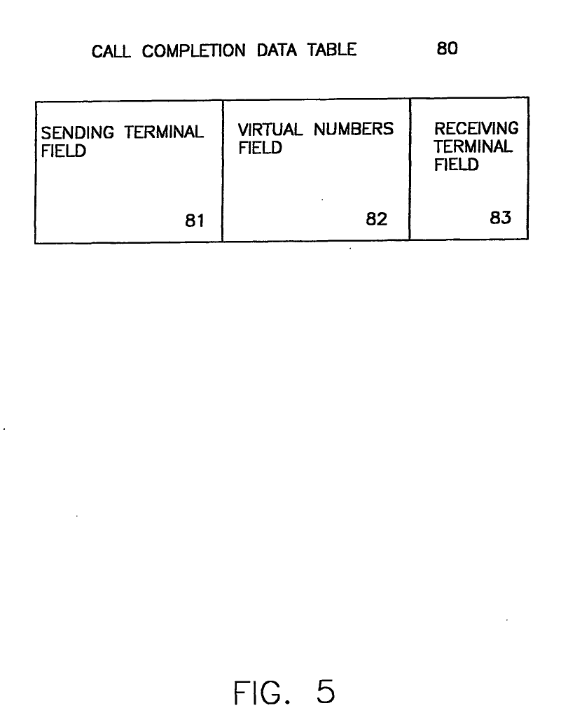

In one embodiment of the present invention as illustrated in FIG. 5, a call completion data table 80 is provided configured to store a unique calling code for communications between any two subscribers 4. Call completion table 80 can be stored in several places including but not limited to user database 16, subscriber information table 60, message delivery subsystem 17 and/or any other data storage structure in system 2. Call completion data table 80 stores the necessary information to maintain a virtual number system such that message delivery subsystem 17 can complete a call between any two subscribers 4 using that virtual system.

In one embodiment of the present invention, as illustrated in FIG. 5, call completion data table 80 maintains several fields which may include but is not limited to, sending terminal field 81, virtual number field 82, and receiving terminal field 83.

Sending terminal field 81 is configured to store information regrading a unique identifier or reference representing a originating terminal. Virtual number field 82 is configured to store information regarding a virtual numeric address as generated by system 2 from the existing trunk lines from the various service providers. Receiving terminal field 83 is configured to store information regarding a unique identifier or reference representing the addressee of the call A more detailed description of the operation of the virtual number system operated by message deliver module 17 using call completion data table 80 will be described in more detail below.

It should be noted that the above description of the components of system 2 is intended only as an example of one design for system 2. However, any similar cross platform message system which utilizes similar components to perform similar group and channel functions is within the contemplation of the present invention.

In Operation,

Utilizing the structure and software architecture described above, subscribers 4 utilize system 2 to engage in mobile cross-platform personal message delivery community between subscribers 4, and in a mobile content and commerce network between subscribers 4 and channel providers. The various process used in performing these functions is describe below.

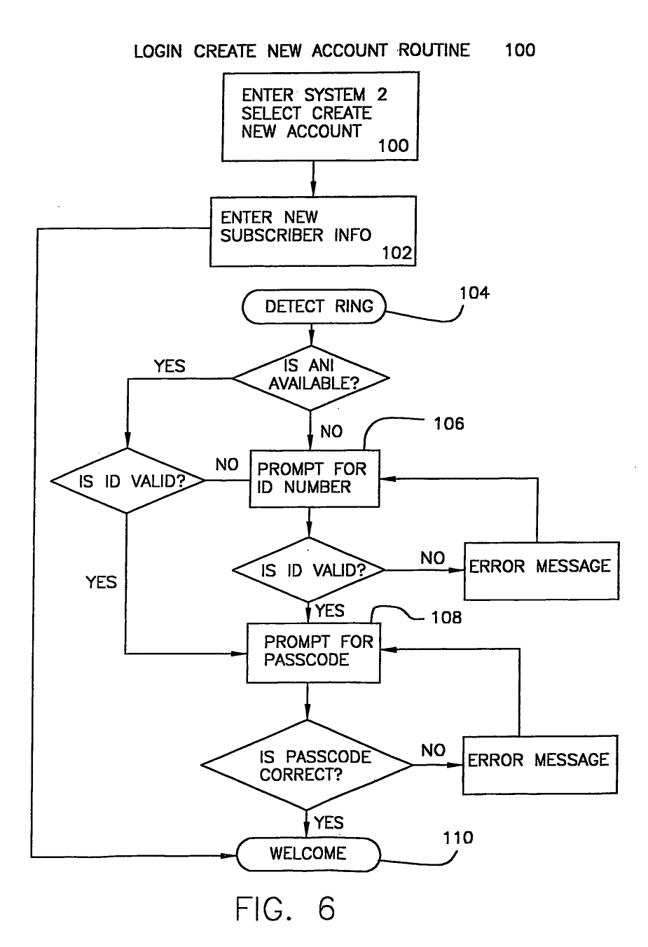

In one embodiment of the present invention, as illustrated in FIG. 6, subscriber 4 sets up an account with system 2. In this process at step 100, subscriber 4 enters system 2 and elects to create a new account. Next, at step 102, subscriber 4 enters the necessary information required to open an account, such that system 2 can create a subscriber information table 60 for that subscriber 4. This information includes but is not limited to username, personal information, and PIN.

Subscriber 4 then proceeds to logging into system 2. (When subscriber 4 signs up with system 2 initially, after entering the required information at step 102, they are already considered logged in and would proceed with operations as if they were already at step 110.)

At step 104, system 2 attempts to recognize subscriber 4 based on the protocol subscriber 4 is using to contact system 2. For example, if subscriber 4 is calling system to via IVR interface 14 then system 2 attempts to recognize the callers ANI (Automatic Number Identifier) such that it can retrieve the username from username field 61 of subscriber table 60 for that subscriber 4. Alternatively, if subscriber 4 is contacting system 2 via HTTP/WAP interface 8, system 2 may attempt to identify subscriber 4 using a coolie or other web based identification and memory device so as to automatically call up the username of subscriber 4.

If the user name is, recovered automatically subscriber 4 proceeds directly to step 108. However if system 2 is unable to identify subscriber 4 automatically, at step 106, subscriber 4 enters their username as it is stored in username field 61. If the username is valid (ie. in the system), subscriber 4 continues to step 108. If the username is incorrect, subscriber 4 is returned to step 106 to re-enter their username.

At step 108, subscriber 4 enters their PIN as it is stored in PIN field 63. If the information is correct then they proceed to step 110, However, if the PIN is incorrect, subscriber 4 is returned to step 108 to re-enter their PIN. After a valid PIN is entered, at step 110, subscriber 4 enters into their account at system 2.

It should be noted that the-above described login procedure is intended only as an example of one login procedure that could be used by system 2 and is in no way intended to limit the scope of the present invention. Additional features can be added at this stage or features may be deleted provided the overall procedure still functions as a login procedure. Any similar login feature used in conjunction with a similar cross-platform messaging system is within the contemplation of the present invention.

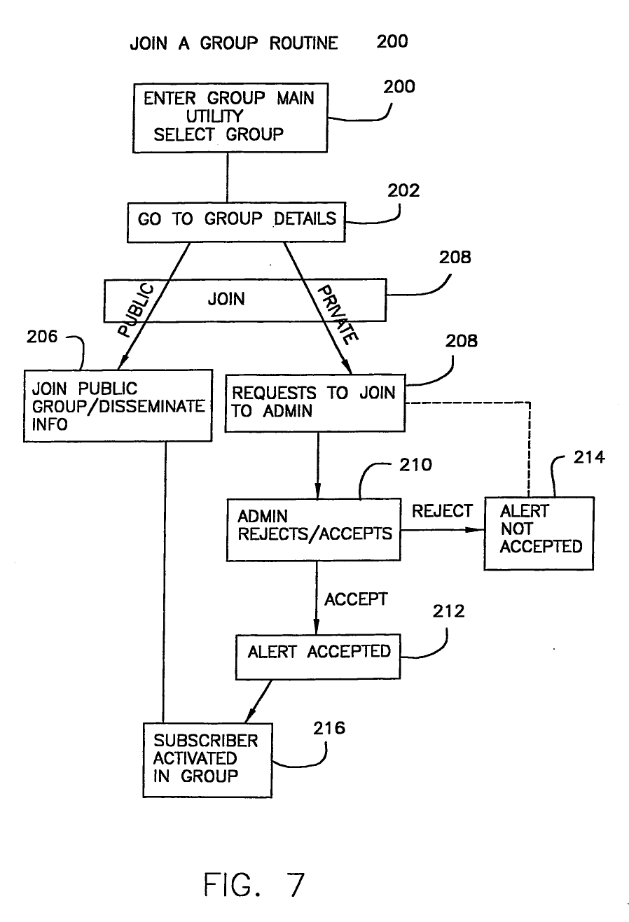

In one embodiment of the present invention, as illustrated in FIG. 7, subscriber 4 joins a group, in system 2. In this process, at step 200, subscriber 4 enters group main page utility 30 and selects a desired group. This selection can be made by browsing the web pages provided by group main page utility 30 or subscriber 4 may search for a group based on some criteria and select a group based on the results produced in group search results utility 38.

After selecting a group, at step 202, subscriber 4 enters group details utility 32 where subscriber 4 peruses the group information and decides in they selected the right group for themselves.

Next, at step 204, subscriber 4 can either automatically join a public group or they can request to join a restricted group. Secrets groups will not be listed and can only be joined by the invite process which is discussed in more detail below.

If subscriber 4 selects to join a open group then at step 206, subscriber 4 activates a join button and they are admitted to that group. System 2 subsequently distributes this information to all relevant places where it is stored such as on that group's group administration utility 34 and subscriber table 60, group field 66. Subscriber 4 can then proceed to step 216 and begin activity in the group.

However, if subscriber 4 elects to join a restricted group, at step 208 subscriber 4 activates a request to join button which forwards their request to the group administration utility 34. At step 210, the group administrator/founder, determines if this subscriber is allowed to join their group. If subscriber 4 is allowed to join, then, at step 212, system 2 sends an alert via alert module 20 notifying subscriber 4 that they are now active and may proceed to step 216 to conduct group activity. If however, at step 210 the group administrator decides not to allow subscriber 4 to join their group, then at step 214, system 2 sends an alert to subscriber 4 via alert module 20 notifying them that they have been denied entry into the group. This terminates the process for subscriber 4 unless they attempt again from step 208.

Assuming subscriber 4 gets into the group, at step 216, subscriber 4 is free to perform any allowable group function as determine by the group administrator.

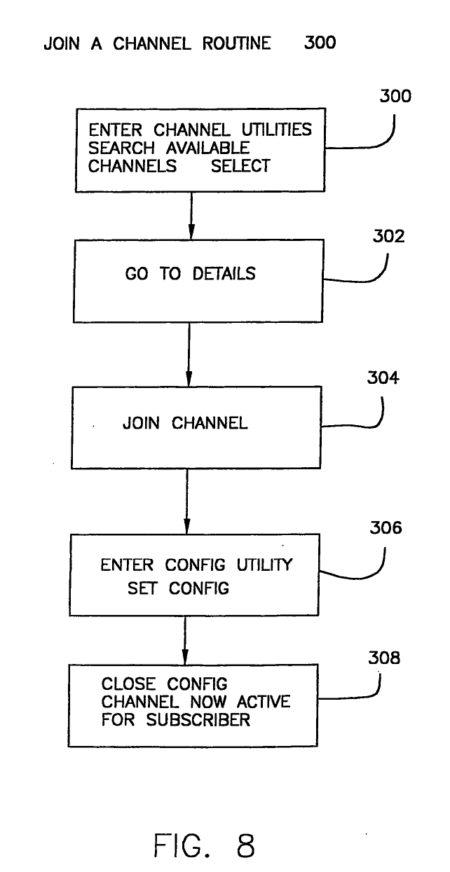

In one embodiment of the present invention, as illustrated in FIG. 8, subscriber 4 joins a channel in system 2. In this process, at step 300, subscriber 4 enters channel main page utility 52 and selects an interesting channel. This selection can be made by browsing the web pages provided by channel main page utility 52 or subscriber 4 may search for a channel based on some criteria and select channel based on the results produced in channel category utility 54.

After selecting a channel, at step 302, subscriber 4 enters channel details utility 56 where subscriber 4 peruses the information on the channel and decides in they selected the right group for themselves. Next, at step 304, subscriber 4 can automatically join the channel as all channels are public. Assuming subscriber 4 joins, system 2 subsequently distributes this information to all relevant places where it is stored such as channel tool utilities 72 and channel field 67 of subscriber table 60.

After joining a channel, at step 306, subscriber 4 enters channel configuration utility 59, as illustrated in FIG. 3A, and sets the parameters for which information they wish to receive. As channels often provide a large sum of information to chose from, subscribers 4 often limit their information received to relevant or interesting material. Next at step 308, after subscriber 4 enters their preferences, subscriber 4 closes the utility and is officially a member of the channel and will receive messages according to the parameters they selected.

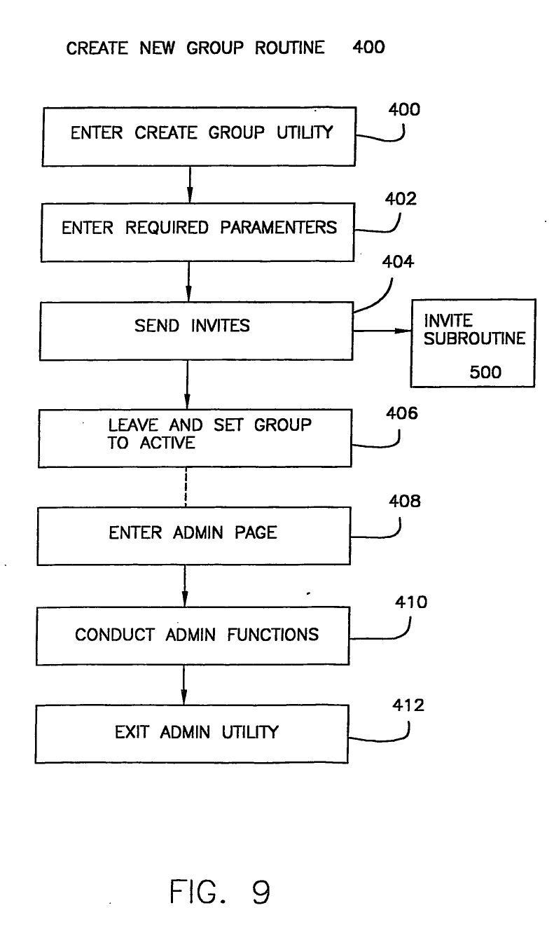

In one embodiment of the present invention, as illustrated in FIG. 9, subscriber 4 enters system 2 and sets up a new group. In this process, at step 400, subscriber 4 enters group main page utility 30 and selects to be sent to create group utility 39, as illustrated in FIG. 2C.

Next, at step 402, subscriber 4 enters all of the necessary information on the pages provided by create group utility 39, as illustrated in FIG. 2C, which may include but is not limited to: naming the group, picking an abbreviation, entering a brief description, selecting whether the group is public, private or secret, selecting who can send messages to the group (open or restricted to creator) and selecting categories (if applicable).

It should be noted that, public groups are open to everyone and found on all public search results, private groups are open to public search but can only be joined with approval of the administrator of the group, secret groups are not open to public searches and can only be joined with approval from the creator/administrator.

Next, after the parameters of the group are set, at step 404, subscriber may choose to send invites out to friends or at random in order to get members to join. The entire invite procedure is discussed below in more detail below in routine 500. After the group creator sends invites, at step 406, subscriber 4 selects the create group button and the group is now effectively open for operation (ie. Listed on group main page utility 30.

At this point, and at any point in the future, at step 408 the creator subscriber 4 of the group may now enter group administration utility 34. Group administration utility 34, as illustrated in FIG. 2B, provides web interfaces for creator subscriber 4 to edit and control the functions of their group.

Thus, at step 410, subscriber 4 can perform any of the actions as detailed in FIG. 2B which may include but are not limited to change group name, record group handle, change group message, boot unruly members, accept or decline requests to join, change the group from/to private/public/secret and/or disband the group. It should be noted that upon acceptance or denial to a group by group administrator, alert module 20, at step 411 sends and alert to that subscriber 4 notifying them of the results.

After group creator subscriber 4 completes the editing/managing functions on administration utility 34, at step 412, subscriber 4 exits administration utility 34 and re-enters the general functions of system 2.

In one embodiment of the present invention, as illustrated in FIG. 10, subscriber 4 enters system 2 and invites a-non-member subscriber into a group. It should be noted that the invite procedure from step 404 above substantially runs this subroutine. In this process, at step 500, a group member subscriber 4 enters group main page utility 30 and selects the invite option. It should be noted that entering the invite process, can be initiated from several other locations within the software of system 2, however, this method has been chosen as an example, the steps to follow are identical, regardless of how the invite process was initiated

Next, at step 502, a user selects a group that they wish to invite a non-member subscriber into. After selecting a group to invite the non-member to, at step 504, member subscriber 4 selects the non-member they wish to invite to that group. This selection can be any member of the system 2 community (ie. a subscriber 4). This member is selected based on non-member subscriber's 4 username as stored in their user name field 61. It should be noted that mass invitations can be implemented by simply adding additional usernames to the invite, however for the purposes of illustration one non-member subscriber 4 is invited.

After the invitation is complete, at step 506, member subscriber 4, selects a send Is option which informs group alert module 20 to send a text invite. At this point two possible processes can occur. If the group is open to the public, then at step 508 alert message is sent directly to the non-member subscriber however if the group is private or secret then, at step 510, alert module 20 send the invite to the group administrator.

If the group is public, system 2 proceeds to step 518, however if the group is private or secret then at step 512, group administrator enters group administration utility 34 and makes the determination to accept or decline the new non-member. If they are denied then, at step 514, the process ends. However, if the non-member subscriber is accepted, then, at step 516, alert module 20 sends a text alert to non-member subscriber 4 based the information contained in preferred format field 65a(text) in non-member's subscriber information table 60. Thus, even if member subscriber enters the invite via HTTP/WAP interface 8, the invite will be sent to non-member subscriber 4 in either e-mail, WAP/HTTP or SMS, based on the non-member's preference.

At step 518, after receiving the invite alert from system 2, non-member subscriber 4 is afforded two option, either accept or decline the invite. If the non-member subscriber 4 declines the invite then at step 520 the process is terminated. However, if non-member subscriber 4 accepts the invite then the non-member is added to the group and the pertinent information is disseminated through system 2, such as information pertaining to group member field 66 and group administration utility 34.

It should be noted that the above described invitation procedure is intended only as an example of one invite procedure that could be used by system 2 and is in no way intended to limit the scope of the present invention. Additional features can be added at this stage such as mass invites or invites to multiple groups, provided the overall procedure still functions as an invite to group procedure. Any similar invite feature used in conjunction with a similar cross-platform messaging system is within the contemplation of the present invention.

In one embodiment of the present invention, as illustrated in FIG. 11, subscriber 4 enters system 2 and sends a text message to another subscriber 4. In this process at step 600 subscriber 4 enters send message module 22 and, as such, enters message window 24, as illustrated in FIG. 2A. It should be noted that there are a number of ways to reach send message module 22 because it appears as a sidebar on most utilities in system 2. Irrespective of the where subscriber 4 reaches sends message module 22, the operation of sending message is substantially the same. If, for example, subscriber 4 enters message window 24 from group details utility 32 it is possible that that group will be defaulted to as the addressee, but subscriber 4 can change that addressee as they choose.

Next at step, 602, sender subscriber 4 selects which subscriber 4 to send a message to. This selection can be made from the address window 24a which is populated by the information in subscriber address field 68 of subscriber table 60, from group window 24b, which is populated by group membership field 66 of subscriber table 60 or the address can be selected by simply entering the desired username into address window 24a.

Next, at step 604, subscriber 4 enters the text of the message into text window 24c of the message window 24. A maximum character length may be imposed at this stage. After the message is complete, at step 606, subscriber sends the message by activating the send message button 24d in window 24.

It should be noted at this point that because of the cross platform nature of system 2, several means are available to send a text message via system 2. Subscriber 4 can enter the message in any format accepted by system 2 which is capable of receiving a text message. For example, text messages can be entered and sent via system 2 by way of WAP/HTTP (as described above), SMS, 2 way paging, and IVR (with text to speech capabilities). Thus, the above example of creating a text message is intended only as an example of one possible method of creating text message and is in no way intended to limit the scope of the present invention Any format accepted by system 2 which can facilitate the creation of text message is within the contemplation of the present invention.

Next at step 608, system 2 reads the addressee information and determines to who and how to the message is to be delivered. If the message is to an individual, system 2 refers to that subscriber's device preference field 65a(text). If the message is for a group, system 2 determines all of the members of the group from group administration utility 34 and determines each one of their preferred device fields 65a(text) formats.

After all of the recipient subscribers 4 are determined and their formats are acknowledged, at step 610, the message is forwarded by system 2 to platform conversion module 9 where the message is converted into all of the necessary formats required to complete delivery of the messages in each of the desired formats. Upon completion of the format conversion, at step 612 platform conversion module 9, delivers the message to all of the necessary interfaces 8, 10, 12 and 14 as required, and the message is delivered to each addressed subscriber 4.

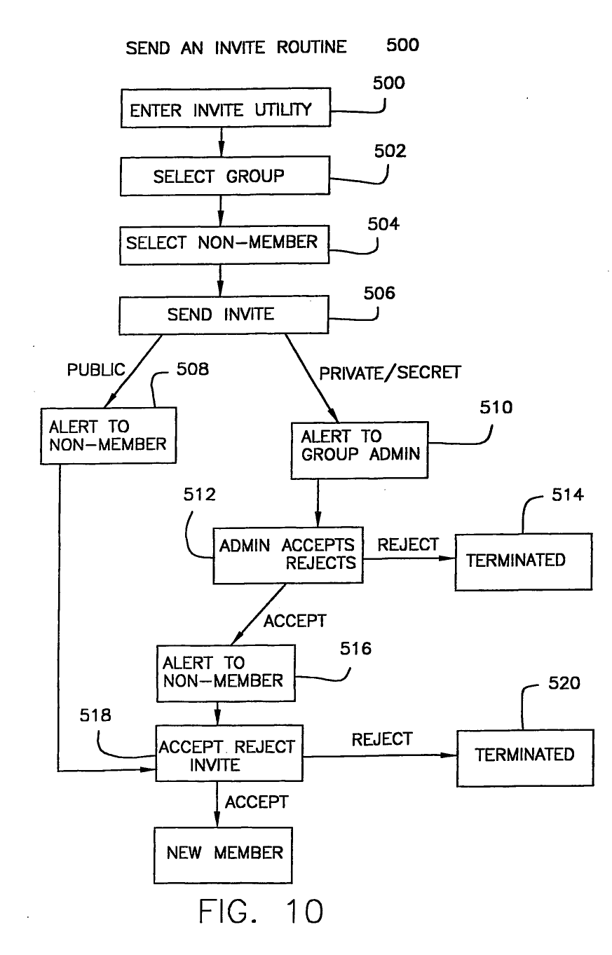

In one embodiment of the present invention, as illustrated in FIG. 12, subscriber 4 sends a voice message through system 2. In this process, at step 700, subscriber 4 enters send message module 22. For voice messages send message module 22 accepts voice messages from IVR interface 14, or from a WAV file sent via HTTP/WAP interface 8. However, it should be noted that there are a number of ways to reach send a message module 22 for voice messages. For example, using speech-to-text conversions, system 2 may accept a voice message via message window 24 as described above. Also, in addition to IVR, and HTTP, message module 22 may also accept text to speech message input through other means than window 24 such WAP and SMS protocols.

Irrespective of the how subscriber 4 reaches message module 22 for recording a voice message, the operation of sending message is substantially the same. However for the purposes of illustration a typical voice message will be created by a subscriber 4 interacting with system 2 via IVR interface 14, and, as such, this will be used as the example.

Next at step, 702, sender subscriber 4 selects which subscriber 4 to send a message to. This selection can be made by following an IVR logic flow (ie. Press 1 for group XYZ, press 2 for group ABC, press the first four letters of the username etc.). If the voice message is being entered as text, subscriber 4 would just follow the procedures outlined above in routine 600.

Next, at step 704, subscriber 4 enters the message by speaking it, as it as recorded by IVR interface 14 and stored in multimedia database 18. A maximum length may be imposed at this stage. After the message is complete, at step 706, subscriber sends the message by activating send message module 22 as indicated by the IVR.

Next, at step 708, system 2 reads the addressee information and determines to who and how to the message is to be delivered. If the message is to an individual, system 2 refers to that subscriber's device preference field 65b(voice). If the message is for a group, system 2 determines all of the members of the group from the group administration utility 34 and determines each one of their preferred device fields 65b(voice) formats.

After all of the recipient subscribers 4 are determined and their formats are acknowledged, at step 710, alert module 20 sends a text alert notifying recipient subscriber 4 of an incoming voice message. This alert is sent by alert module 20 to platform conversion module 9 where the message is converted into all of the necessary formats required to complete delivery of the messages in each of the desired formats. The alert is sent in text format and as such the delivery method is dictated by device preference field 65a(text).

Upon completion of the format conversion, at step 712, platform conversion module 9, delivers the alert to all of the necessary interfaces 8, 10, 12 and 14 as required and the message is delivered to each addressed subscriber 4.

Upon receipt of the alert, at step 714, subscriber 4 accesses system 2 in some method such as IVR or HTTP, and elects to either listen to the message or delete it. It should be noted that it is possible that subscriber 4 may prefer to receive voice messages via a speech to text message, which system 2 would determine from device preference 65b(voice) field of subscriber table 60. As such, it is in fact possible for a voice message to be originally created in text and eventually received in text. The distinguishing factor is that the sending subscriber 4 designated it as a voice message and the message is alerted rather than sent directly.

It should be noted that the above described message sending procedures are intended only as an examples of message sending procedures that could be used by system 2 and are in no way intended to limit the scope of the present invention Additional features can be added at this stage or features may be deleted provided the overall procedures still function as a message sending procedure. Any similar message sending features used in conjunction with a similar cross-platform messaging system is within the contemplation of the present invention.

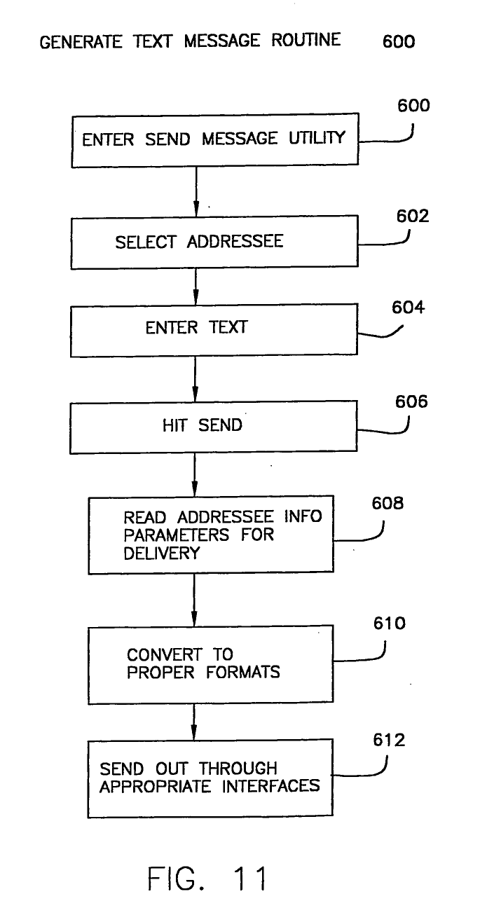

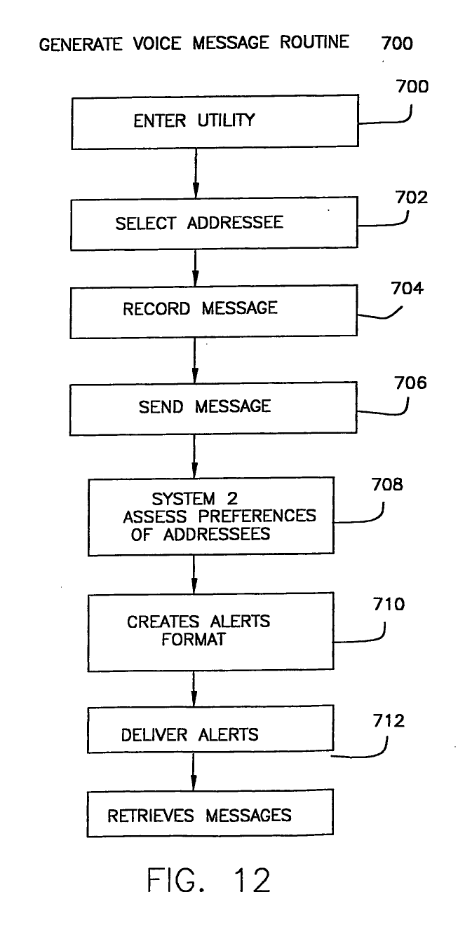

In one embodiment of the present invention, as illustrated in FIG. 13, subscriber 4 enters system 2 receives a multimedia content from a channel provider via WAP/SMS and IVR handler module 19. In this procedure IVR, WAP and SMS interfaces 14, 8 and 12 respectively, work in combination to provide an interactive streaming media function to subscriber 4 of system 2.

As such, at step 800, a subscriber logs into system 2 via a WAP session (referring generally to any user currently logged into system 2 via WAP protocol). Next, at step 802, while subscriber 4 is navigating through the various menus of system 2, system 2 at the request of any number of channel providers sends an alert via alert module 22a, to “push” an alert to subscriber 4, notifying them of a multimedia file they may wish to receive. This multimedia file may be contained on multimedia database 18 if the “pushed” alert is from a channel or it may be contained m IVR database 23 if the message is arriving through system 2 via an outside source.

Without disconnecting the WAP session, at step 804, WAP interface 8 and IVR interface 14 communicate via LAN connection platform conversion module 9 so as to to seamlessly deliver streaming multimedia files.

At step 806, subscriber 4 is prompted to activate a soft key in order to receive the multimedia clip. This soft key is associated with a WA command to send some form of media. The logical control flow used for this message is identical between WAP interface 8 and IVR interface 14. This is made possible by the coordination of the two interfaces by WAP-SMS IVR handler module 19. It should be noted that additional choices could be provided which could allow for other options such as purchase of the multimedia, which would be handled in the same fashion. However for the purposes of illustration, the multimedia delivery is used.

Assuming subscriber 4 decides to accept the invitation and activates the appropriate soft key, at step 808, WAP interface 8 automatically informs IVR interface 14 of an incoming call that is about to be placed from subscriber 4 mobile device. At step 810, subscriber's 4 mobile device automatically calls IVR interface 14 on the link provided by WAP interface 8.

A similar method of operation for requesting steaming multimedia files is available for subscribers 4 who do not have WAP capabilities by using SMS in “passive mode.” In this mode, subscriber 4 is sent an invitation to receive a multimedia clip via an SMS text message with a special embedded IVR number. Simultaneously, SMS interface 12 notifies IVR interface 14 in advance of a potential multimedia request Assuming subscriber 4 accepts the invitation, subscribers mobile device calls the IVR special embedded IVR number provided in the SMS messages and using the initial information provided by SMS interface 12, IVR identifies subscriber 4 and sends the multimedia clip.

At step 812, IVR interface uses a special routing number, locates subscriber 4, and delivers the multimedia file directly from database 18 or 23 to subscriber 4. These types of deliveries from IVR interface 14 can be based on messages generated in a WAP sessions or the can be based on a flag set in database 18 or 23 associated with subscriber 4 checked when IVR interface 14 background logs-in subscriber 4.

Upon completion, at step 814, subscriber 4 is prompted by IVR interface 14 with several options regarding the multimedia files such as: purchase the CD; replay the clip; hear another clip; check out other features; or return to wireless internet (WAP) session. Subscriber 4 can either return to the WAP session in progress disconnecting them from the 1R or they can choose from the other options.

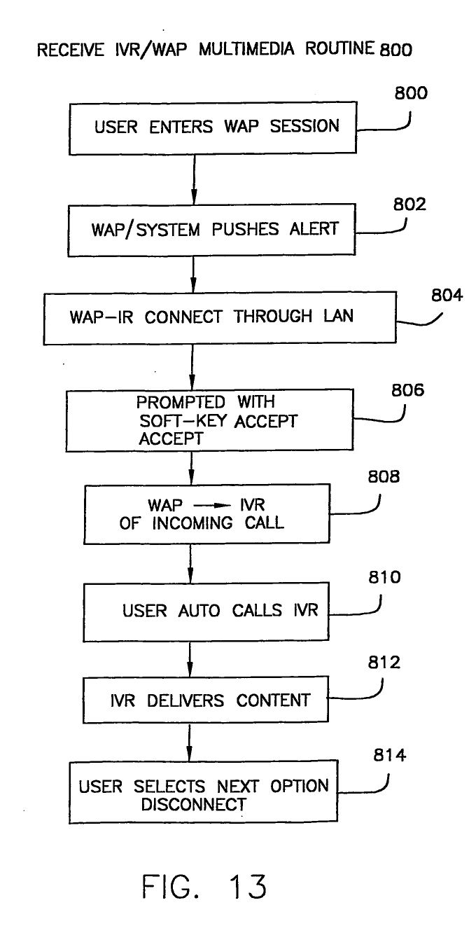

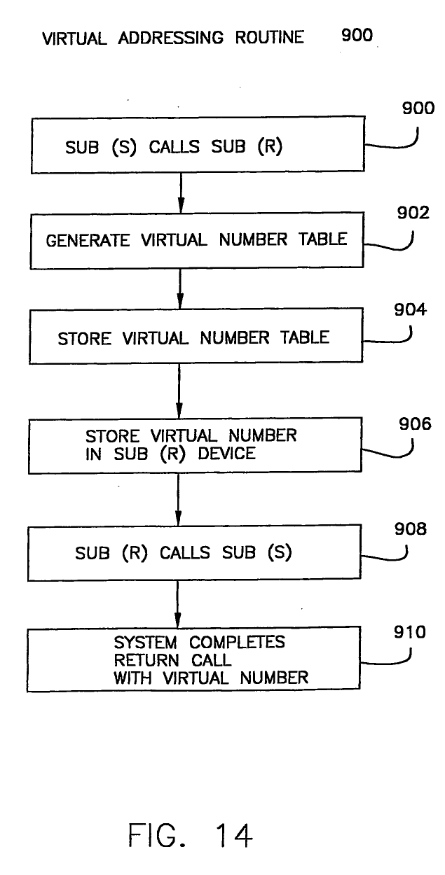

In one embodiment of the present invention, as-illustrated in FIG. 14, subscriber 4 places a call to another subscriber 4 and message delivery subsystem 17 creates a virtual number, completes the call and stores the virtual number for future use.

This method utilizes a block of telephone numbers (addresses) in such a way as to uniquely identify each subscriber 4 by a single address on a service provider's network, using a total number of addresses from the service provider which is less than the total number of subscribers 4 on system 2. This feature is employed with a asynchronous text messages, however, that is in no way intended to limit the scope of the present invention. Any telephony communications utilizing this virtual addressing system such as with synchronous voice telephone calls is also within the scope of the present invention.

Typically a provider allocates 10,000 address blocks, however, there are more than 10,000 subscriber 4 on system 2. The virtual addressing method provided by message deliver subsystem 17 on system 2 allows an arbitrarily large number of subscribers 4 to be addressed with a limited range of addresses.

Thus, for each mobile device in system 2 that receives a message, there are 10,000 (based on this example) numbers which can be assigned. If a single user exceeds 10,000 incoming message sources, a least recently used (LRU) system can be implemented. As such, message delivery subsystem 17 of system 2, provides a means for each subscriber's 4 mobile device to use the same 10,000 number base to communicate even if more than 10,000 users exist.

In operation, at step 900, subscriber 4(s) begins by placing a call to subscriber 4(r). The designations (s) and (r) are added for this feature to alleviate any confusion as to who the sender and receiver of the call are. The calls are managed through system 2 to maintain subscriber 4 anonymity via the use of their username, which necessitates the virtual numbering system. If subscribers 4 freely exchange their numbers then they are free to contact one another independent of system 2 in which case there is no need for this numbering system. The virtual numbering system described herein is only for subscriber 4 to subscriber 4 communication via usernames through system 2.

Next at step 902, after system 2 has identified the sender and receiver, a three-part data structure call completion data table 80 is generated including the fields of: a unique identifier field or reference 81 representing the terminal (sender) on the affected network; a virtual numeric address 82; and a unique identifier field or reference 83 representing the individual who is addressed (receiver). This information is used to complete the initial call.

At step 904, system 2 records call completion data table 80 such that it maintains a database of virtual addresses in either database 16 or in message delivery subsystem 16. Call completion data table contains references not only to the target mobile device of subscriber 4(r) (field 83) but also the mobile device of subscriber 4(s) (field 81) where the message originated. Only one address structure is stored in system 2 for any given combination of a numeric address, an originating device and a target device (ie. call completion data table 80).

At step 906, the combined virtual number as contained in call completion data table 80 is stored in subscriber's 4(r) mobile device as a virtual number. Next, at step 908, subscriber 4(r) attempts a return call to subscriber 4(s), and system 2 identifies the incoming call as originating with subscriber 4(r) by way of a recognition function housed in IVR interface 14.

Thus, at step 910, message deliver subsystem 17, attached to IVR interface 14, recalls call completion data table 80. Upon retrieval, message deliver subsystem 17, at step 912 initiates the return call using the virtual number stored in the directory in call completion data table 80. This virtual number, created when subscriber 4(s) initially called subscriber 4(r), is now used by system 2 to complete all future calls that originate from subscriber 4(r) back to subscriber 4(s). This process is repeated for all calls made to subscriber's 4 device until 10,000 incoming calls are reached.

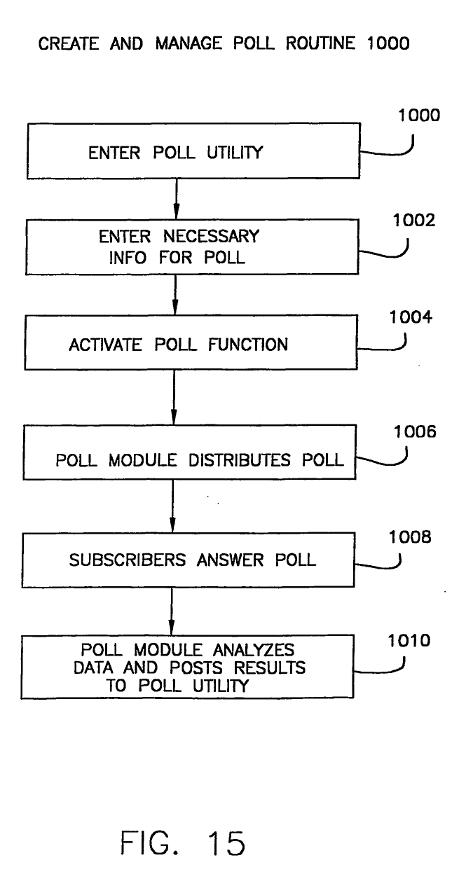

In one embodiment of the present invention, as illustrated in FIG. 15, a content provider creates a poll and subscriber 4 responds. In this process, at step 1000, a content provider or channel operator enters channel toolset utility 72, where they enter create/manage poll utility 74. Next, at step, 1002, the channel or content provider enters the appropriate information into the required locations, providing the questions and the set of possible answers.

It should be noted that although this features is generally referred to as a poll, the types of questions that can be responded to include any number of questions related to a particular channel provider's channel. For example, the proprietor of movie theater channel may wish to generate a poll which requests movie review results. Likewise, a sports related channel may wish to create a poll relating to a featured game, such as “which game would you like for us to feature on our show” Any type of question with a limited (multiple choice) response is within the contemplation of the present invention.

Upon completion of the poll information, at step 1004, the channel or content provider activates the poll function and the information is sent to poll module 55 which administrates the poll. Next, at step 1006, system 2 distributes the poll questions and accompanying response options to subscribers 4 specified by the channel or content provider. In the event the content provider maintains a channel, the distribution list is most likely the member subscribers 4 to their channel. It should be noted that the existence of polls as type of information to be received is listed on subscriber 4 side channel configuration utility 59 such that subscriber 4 channel members can elect whether or not to receive poll questions.

During distribution, poll module 55 works in conjunction with the information device preferences field 65a(text) of subscriber table 60 and with platform conversion module 9 to ensure the distribution occurs in the desired formats.

Next, at step 1008, after subscriber 4 receives the poll question, they can respond to it using any one of the interfaces 8, 10, 12 or 14 provided that the format supports a means to communicate the multiple choice response (most formats). At step 1010, after system 2 receives the response, the information is forwarded to poll module 55 for compilation of the results. Upon completing the compilation of the results, at step 1012, poll module 55 sends the results back to the content or channel provider where they are stored for viewing in poll utility 74.

In another embodiment of the present invention, poll module 55 and poll utility 74 can work in conjunction with scheduling channel utility 73 such that a new poll can be disseminated automatically on a regular basis provided the content is set in advance. This would allow a content or channel provider to create polls well in advance and send them on a schedule or possibly even send the same poll repeatedly, assuming the content for the poll is not stale.

It should be noted that the above described polling procedure is intended only as an example of one polling procedure that could be used by system 2 and is in no way intended to limit the scope of the present invention. Additional features can be added at this stage or features may be deleted provided the overall procedure still functions as a polling procedure. Any similar polling feature used in conjunction with a similar cross-platform messaging system is within the contemplation of the present invention.

While only certain features of the invention have been illustrated and described herein, many modifications, substitutions, changes or equivalents will now occur to those skilled in the art It is therefore, to be understood that this application is intended to cover all such modifications and changes that fall within the true spirit of the invention.

1. A personal message system comprising:
a plurality of interfaces configured to interface with a plurality of subscribers communication devices using a plurality of formats;
a group services module configured to maintain communications among groups of said subscribers; and
a platform conversion module coupled to said plurality of interfaces and said group services modules configured to connect each of Said plurality of subscribers within a group, regardless of the communication protocols used by said subscribers.

2. A personal message system as claimed in claim 1, wherein one of said plurality of interfaces is an Hypertext Transfer Protocol/Wireless Application Protocol interface.

3. A personal message system as claimed in claim 2, wherein one of said plurality of interfaces is a Simple Mail Transfer Protocol interface.

4. A personal message system as claimed in claim 3, wherein one of said plurality of interfaces is a Short Message Service/2-way paging protocol interface.

5. A personal message system as claimed in claim 4, wherein one of said plurality of interfaces is an Interactive Voice Response protocol interface.

6. A personal message system as claimed in claim 1, further comprising a personal home page service module configured to provide personal mobile home pages for subscribers on said messaging system.

7. A personal message system as claimed in claim 1, wherein said group service module further comprises an alert module configured to provide alerts to said plurality of subscribers so as to alert them to incoming messages.

8. A personal message system as claimed in claim 1, wherein said group service module further comprises a send message module such that said plurality of subscribers can formulate messages to be sent through said messaging system to other said subscribers.

9. A personal message system as claimed in claim 1, wherein said group service module further comprises a group module configured to allow said subscribers to create, and send messages to and receive messages from subscribers of said groups.

10. A personal message system as claimed in claim 9, further comprising a group main page utility configured to display of a list of said groups.

11. A personal message deliver system as claimed in claim 9, further comprising a group details utility configured to list the details of said groups including number of members, number of messages per day.

12. A personal message system as claimed in claim 9, further comprising group administration utility configured to provide administration function for said group including allowing in new subscribers, removing existing subscribers and setting parameters for group actions.

13. A personal message system as claimed in claim 9, further comprising a group history page configured to store the history of messages sent by said subscribers to said group.

14. A personal message system as claimed in claim 10, further comprising a group search results utility configured to provide search results for searches conducted from said group main page utility.

15. A personal message system as claimed in claim 9, further comprising a create group utility configured to allow said subscribers to create a new group for said messaging system.

16. A personal message system as claimed in claim 1, wherein said group service module further comprising a group membership module configured to allow said subscribers with the necessary utilities-to facilitate the membership functions of said groups.

17. A personal message system as claimed in claim 16, further comprising a request to join utility configured to allow a subscriber to request to join one of said groups.

18. A personal message system as claimed in claim 16, further comprising an invite to group utility configured to allow a subscriber of one of said groups to invite another non-member subscriber to said group.

19. A personal message system as claimed in claim 16, further comprising an accept invite utility configured to allow a subscriber who receives an invite to one of said groups to accept or reject the invitation.

20. A personal message system as claimed in claim 16, further comprising a member directory utility configured to provide a list of the member subscribers to said groups.

21. A personal message system as claimed in claim 1, further comprising a user database configured to store information relating to the accounts of said plurality of subscribers.

22. A personal message system as claimed in claim 1, further comprising a multimedia database configured to store information relating to multimedia data for delivery to said plurality of subscribers.

23. A personal message system comprising:
a plurality of interfaces configured to interface with a plurality of subscribers communication devices using a plurality of formats;
a channel services module configured to maintain communications from a content provider to said subscribers; and
a platform conversion module coupled to said plurality of interfaces and said channel services modules configured to connect each of said plurality of subscribers with said content providers, regardless of the communication protocols used by said subscribers.

24. A personal message system as claimed in claim 23, wherein one of said plurality of interfaces is an Hypertext Transfer Protocol/Wireless Application Protocol interface.

25. A personal message system as claimed in claim 24, wherein one of said plurality of interfaces is a Simple Mail Transfer Protocol interface.

26. A personal message system as claimed in claim 25, wherein one of said plurality of interfaces is a Short Message Service/2-way paging protocol interface.

27. A personal message system as claimed in claim 26, wherein one of said plurality of interfaces is an Interactive Voice Response protocol interface.

28. A personal message system as claimed in claim 23, further comprising a personal home page service module configured to provide personal mobile home pages for subscribers on said messaging system.

29. A personal message system as claimed in claim 23, wherein said channel service module further comprises an alert module configured to provide alerts to said plurality of subscribers so as to alert them to incoming messages.

30. A personal message system as claimed in claim 23, wherein said channel service module further comprises a send message module such that said content provider can formulate messages to be sent through said messaging system to said subscribers.

31. A personal message system as claimed in claim 23, wherein said channel service module further comprises a poll module configured to provide said content provider with the ability to send polls to said channel subscribers.

32. A personal message system as claimed in claim 23, wherein said channel service module further comprises a channel module configured to allow said content providers create and send messages to said subscribers of said channel.

33. A personal message system as claimed in claim 32, further comprising a channel main page utility configured to display of a list of said channels.

34. A personal message system as claimed in claim 32, further comprising a channel details utility configured to list the details of said channels including the number of messages per day and a description of the content of those channels.

35. A personal message system as claimed in claim 32, further comprising a channel categories utility configured to list said channels into categories based on their content.

36. A personal message system as claimed in claim 32, further comprising a channel history utility configured to store the history of messages sent by said content provider to said channel.

37. A personal message system as claimed in claim 32, further comprising a channel configuration utility configured to allow said channel subscribers to control the content that they receive from said channel.

38. A personal message system as claimed in claim 23, wherein said channel service module further comprising a channel administration module configured to allow said content providers administrate said channels.

39. A personal message system as claimed in claim 38, further comprising a channel text message utility configured to allow said content provider to generate a text message to be sent to said member subscribers of said channel.

40. A personal message system as claimed in claim 38, further comprising a channel voice message utility configured to allow said content provider to generate a voice message to be sent to said member subscribers of said channel.

41. A personal message system as claimed in claim 38, further comprising a channel toolset utility configured to allow said content provider to administrate the content of said channel.

42. A personal message system as claimed in claim 38, further comprising a channel message scheduling utility configured to allow a content provider to pre-schedule the deliver of messages to said member subscribers of said channel in advance.

43. A personal message system as claimed in claim 38, further comprising a channel poll utility configured to allow said channel provider to enter the information necessary to conduct a poll.

44. A personal message system as claimed in claim 23, further comprising a user database configured to store information relating to the accounts of said plurality of subscribers.

44. A personal message system as claimed in claim 23, further comprising a multimedia database configured to store information relating to multimedia data of said content providers for delivery to said plurality of subscribers.

45 A personal message system comprising:
a plurality of interfaces configured to interface with a plurality of subscribers communication devices using a plurality of formats;
a group services module configured to maintain communications among groups of said subscribers;
a platform conversion module coupled to said plurality of interfaces and said group services modules configured to connect each of said plurality of subscribers within a group, regardless of the communication protocols used by said subscribers; and
a message delivery subsystem coupled to one of said plurality of interfaces configured to create a virtual number based on a the devices of both said receiving and sending said subscriber and a randomly generated virtual number which are stored in a call completion data table.

46. A personal message system as claimed in claim 45, wherein said call completion data table maintains a receiving subscriber device field configured to store the wireless number associated with the device of the call receiving subscriber.

47. A personal message system as claimed in claim 45, wherein said call completion data table maintains a virtual number field configured to store the virtual number associated with the call between said devices of the call receiving and call sender subscribers.

48. A personal message system as claimed in claim 45, wherein said call completion data table maintains a sending subscriber device field configured to store the wireless number associated with the device of the call sending subscriber

49. A personal message system comprising:
a plurality of interfaces configured to interface with a plurality of subscribers communication devices using a plurality of formats;
a group services module configured to maintain communications among groups of said subscribers;
a platform conversion module coupled to said plurality of interfaces and said group services modules configured to connect each of said plurality of subscribers within a group, regardless of the communication protocols used by said subscribers; and
a wireless application protocol—short message service/interactive voice response handler module coupled to said platform conversion module configured to provide interactive voice response links into a wireless application protocol sessions such that a subscriber in said wireless application protocol sessions can directly link to an interactive voice response session so as to directly download a multimedia file.

50. A personal message system as claimed in claim 49, further comprises an interactive voice response subsystem handler module, coupled to said wireless application protocol—short message service/interactive voice response handler module configured to provide an external interactive voice response session from an independent multimedia content provider.

51. A personal message system as claimed in claim 50, further comprises an interactive voice response multimedia database, coupled to said interactive voice response subsystem handler module configured to store multimedia content to be delivered by said interactive voice response subsystem handler module and said wireless application protocol—short message service/interactive voice response handler module.

52. A personal message system comprising:
a plurality of interfaces configured to interface with a plurality of subscribers communication devices using a plurality of formats;
a group services module configured to maintain communications among groups of said subscribers;
a platform conversion module coupled to said plurality of interfaces and said group services modules configured to connect each of said plurality of subscribers within a group, regardless of the communication protocols used by said subscribers; and
a subscriber information table configured to store the information necessary for said platform conversion module to send messages to said subscribers in the proper format.

53. A personal message system as claimed in claim 52, further comprising a username field configured to store information pertaining to said subscribers username, used to identify said subscriber to said other subscribers on said message system.

54. A personal message system as claimed in claim 52, further comprising a personal information/e-mail field configured to store information pertaining to said subscribers personal information such as real name, mailing address, phone number and e-mail address for use by said message system in contacting said subscriber.

55. A personal message system as claimed in claim 52, further comprising a Personal Identification Number (PIN) field configured to store information pertaining to said subscribers personal identification number used by said message system to restrict access to said subscribers account.

56. A personal message system as claimed in claim 52, further comprising a validation list field configured to store information pertaining to said subscribers personal communication devices which are recognized by said message system.

57. A personal message system as claimed in claim 52, further comprising a preferred voice field configured to store information pertaining to said subscribers preferred device for receiving voice messages from said message system.

58. A personal message system as claimed in claim 52, further comprising a preferred text field configured to store information pertaining to said subscribers preferred device for receiving text messages from said message system.

59. A personal message system as claimed in claim 52, further comprising a groups field configured to store information pertaining to said subscribers group membership record.

60. A personal message system as claimed in claim 52, further comprising a channel field configured to store information pertaining to said subscribers channel membership record.

61. A personal message system as claimed in claim 52, flier comprising a addresses field configured to store information pertaining to said subscribers address book of all other subscribers on said message system that said subscriber has previously contacted.

62. A personal message system as claimed in claim 52, further comprising a history field configured to store information pertaining to said subscribers recently received messages from said message system

63. A method for sending a message on a personal messaging system having a plurality of interfaces, a group services module and a platform conversion module, said method comprising the steps of:
sending a message to said message system via any one of said plurality of interfaces;
sending said message to said group services module for sending said message to said subscriber members of said group;
reformatting said message in said platform conversion module into various formats corresponding to said group member subscriber preferences; and
delivering said message through said plurality of interfaces to said members of said group.

64. A method for delivering a message on a personal messaging system having a plurality of interfaces, a channel services module and a platform conversion module, said method comprising the steps of:
creating a channel message on said message system;
sending said message to said channel services module for sending said message to said subscribers members of said channel;
reformatting said message in said platform conversion module into various formats corresponding to said channel member subscriber preferences; and
delivering said message through said plurality of interfaces to said members of said channel.
